(19) United States
(12) Patent Application Publication
(10) Pub. No.: US 2013/0170553 A1
(43) Pub. Date: Jul. 4, 2013

(54) CODING MOTION VECTOR DIFFERENCE

(71) Applicant: QUALCOMM Incorporated, San Diego, CA (US)

(72) Inventors: Jianle Chen, San Diego, CA (US); Vadim Seregin, San Diego, CA (US); Xianglin Wang, San Diego, CA (US); Marta Karczewicz, San Diego, CA (US)

(73) Assignee: QUALCOMM INCORPORATED, San Diego, CA (US)

(21) Appl. No.: 13/733,757

(22) Filed: Jan. 3, 2013

Related U.S. Application Data
(60) Provisional application No. 61/583,155, filed on Jan. 4, 2012.
(60) Provisional application No. 61/584,085, filed on Jan. 6, 2012.
(60) Provisional application No. 61/591,730, filed on Jan. 27, 2012.

(51) Int. Cl. H04N 7/26

(52) U.S. Cl. CPC H04N 19/00569
USPC 375/240.16

(57) ABSTRACT

The techniques described in this disclosure may be generally related to identifying when motion vector difference (MVD) is skipped for one or both reference picture lists. The techniques may further relate to contexts for signaling MVD values. The techniques may also be related to syntax that indicates when at least one of the MVD values is zero.

This application claims the benefit of:
U.S. Provisional Application 61/583,155 filed Jan. 4, 2012;
U.S. Provisional Application 61/584,085 filed Jan. 6, 2012; and
U.S. Provisional application 61/591,730, filed Jan. 27, 2012, the entire content of each of which is hereby incorporated by reference in its entirety.

### TECHNICAL FIELD

This disclosure relates to video coding and, more particularly, to techniques related to motion vector difference.

### BACKGROUND

Digital video capabilities can be incorporated into a wide range of devices, including digital televisions, digital direct broadcast systems, wireless broadcast systems, personal digital assistants (PDAs), laptop or desktop computers, tablet computers, e-book readers, digital cameras, digital recording devices, digital media players, video gaming devices, video game consoles, cellular or satellite radio telephones, so-called “smart phones,” video teleconferencing devices, video streaming devices, and the like. Digital video devices implement video compression techniques, such as those described in the standards defined by MPEG-2, MPEG-4, ITU-T H.263, ITU-T H.264/MPEG-4, Part 10, Advanced Video Coding (AVC), the High Efficiency Video Coding (HEVC) standard presently under development, and extensions of such standards. The video devices may transmit, receive, encode, decode, and/or store digital video information more efficiently by implementing such video compression techniques.

Video compression techniques perform spatial (intra-picture) prediction and/or temporal (inter-picture) prediction to reduce or remove redundancy inherent in video sequences. For block-based video coding, a video slice (i.e., a video picture or a portion of a video picture) may be partitioned into video blocks, which may also be referred to as treeblocks, coding units (CUs) and/or coding nodes. Video blocks in an intra-coded (I) slice of a picture are encoded using spatial prediction with respect to reference samples in neighboring blocks in the same picture. Video blocks in an inter-coded (P or B) slice of a picture may use spatial prediction with respect to reference samples in neighboring blocks in the same picture or temporal prediction with respect to reference samples in other reference pictures. Pictures may be referred to as frames, and reference pictures may be referred to a reference frames.

Spatial or temporal prediction results in a predictive block for a block to be coded. Residual data represents pixel differences between the original block to be coded and the predictive block. An inter-coded block is encoded according to a motion vector that points to a block of reference samples forming the predictive block, and the residual data indicating the difference between the coded block and the predictive block. An intra-coded block is encoded according to an intra-coding mode and the residual data. For further compression, the residual data may be transformed from the pixel domain to a transform domain, resulting in residual transform coefficients, which then may be quantized. The quantized transform coefficients, initially arranged in a two-dimensional array, may be scanned in order to produce a one-dimensional vector of transform coefficients, and entropy coding may be applied to achieve even more compression.

### SUMMARY

The techniques described in this disclosure are generally related to video coding, and more particularly coding of a motion vector difference (MVD) in a motion vector prediction process such as advanced motion vector prediction (AMVP). The MVD refers to a difference between a motion vector predictor and an actual motion vector for a block to be inter-coded. In some examples, a video coder determines whether MVD skipping is enabled for a block and with respect to which reference picture list the MVD skipping is enabled. MVD skipping refers to instances where the video coder does not code (e.g., encode or decode) the MVD (i.e., the difference between the motion vector predictor and the actual motion vector for the block).

The disclosure also describes techniques for using different contexts for coding the motion vector differences with respect to pictures identified in different reference picture lists. Also, it may be possible for at least one component of the MVD to be zero. Some of the examples described in this disclosure are also directed to the manner in which to code the MVD where at least one of the components of the MVD is zero.

In one example, the techniques are directed to a method for coding video data. The method includes coding a first motion vector difference (MVD) value for a first motion vector of a bi-predicted block that refers to a picture in a first reference picture list with a first context model, and coding a second MVD value for a second motion vector of the bi-predicted block that refers to a picture in a second reference picture list with a second, different context model.

In one example, the techniques are directed to a device for coding video data. The device includes a video coder that is configured to code a first motion vector difference (MVD) value for a first motion vector of a bi-predicted block that refers to a picture in a first reference picture list with a first context model, and code a second MVD value for a second motion vector of the bi-predicted block that refers to a picture in a second reference picture list with a second, different context model.

In one example, the techniques are directed to computer-readable storage medium having instructions stored thereon that when executed cause one or more processors to code a first motion vector difference (MVD) value for a first motion vector of a bi-predicted block that refers to a picture in a first reference picture list with a first context model, and code a second MVD value for a second motion vector of the bi-predicted block that refers to a picture in a second reference picture list with a second, different context model.

In one example, the techniques are directed to a device that includes means for coding a first motion vector difference (MVD) value for a first motion vector of a bi-predicted block that refers to a picture in a first reference picture list with a first context model, and means for coding a second MVD value for a second motion vector of the bi-predicted block that refers to a picture in a second reference picture list with a second, different context model.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a block diagram illustrating an example video encoding and decoding system that may utilize the techniques described in this disclosure.

FIG. 2 is a block diagram illustrating an example video encoder that may implement the techniques described in this disclosure.

FIG. 3 is a block diagram illustrating an example video decoder that may implement the techniques described in this disclosure.

FIG. 4 is a flowchart illustrating an example operation in accordance with one or more example techniques described in this disclosure.

FIG. 5 is a flowchart illustrating another example operation in accordance with one or more example techniques described in this disclosure.

FIG. 6 is a flowchart illustrating another example operation in accordance with one or more example techniques described in this disclosure.

### DETAILED DESCRIPTION

As described in more detail below, in some examples, rather than signaling a motion vector for a current video block that is to be inter-predicted, a video encoder signals a residual between a motion vector predictor and the actual motion vector for the current block. The actual motion vector may refer to the motion vector that would be selected for the block in a motion estimation process. A motion vector predictor refers to a motion vector, associated with a different block, that is used as a prediction of the actual motion vector. The phrase “motion vector difference” or MVD is used to refer to the residual (i.e., difference or error value) between the motion vector predictor and the actual motion vector for the current block. In some instances, the MVD may be equal to zero (e.g., if the motion vector predictor and actual motion vector are identical). For a bi-predicted block there may be two motion vectors (i.e., a first motion vector and second motion vector). In this example, there are two MVDs, one for each of the two motion vectors, and the MVD value for one or both of the MVDs may be zero.

The examples described in this disclosure provide for functionally flexible and coding efficient techniques for coding the MVD values in examples where one or both of the MVD values is zero, and/or in other examples where either MVD is not necessarily equal to zero. As one example, the techniques described in the disclosure allow for the skipping of the coding of MVD values for all blocks within a picture, for all blocks within a slice of the picture, or for a particular block. Also, the techniques allow for skipping of the coding of the MVD at the picture level, slice level, or block level when the motion vector refers to a picture in a first reference picture list or a picture in a second reference picture list, or both reference picture lists.

Skipping of the coding of the MVD, which is referred to as MVD skipping, means that the video encoder does not signal the residual between the motion vector predictor and the actual motion vector, thereby saving bandwidth. In MVD skipping, the video decoder sets the motion vector predictor as the motion vector for the current block. In other words, in MVD skipping, the video decoder assumes that the residual between the motion vector predictor and the actual motion vector for the current block is zero.

In some examples, to enable MVD skipping, the video encoder signals a plurality of bits that indicate whether MVD skipping is enabled, and with respect to which reference picture list or lists MVD skipping is enabled. In some examples, to enable MVD skipping, the video encoder need not necessarily signal the plurality of bits. Rather, the video decoder may determine (e.g., by inference) that MVD skipping is enabled based on the manner in which blocks neighboring or proximate to the current block are predicted.

In this manner, the techniques allow for functional flexibility in defining whether MVD skipping is enabled for which one of the reference picture lists or for both reference picture lists, and enabled for all blocks in a picture, for all blocks in a slice of the picture, or for a particular block. In some other examples (i.e., those techniques that are not in accordance with the techniques described in this disclosure), MVD skipping is only enabled for one of the reference picture lists, and only enabled at the picture level. Such limitations on the MVD skipping may result in poorer inter-prediction as compared to MVD skipping with functional flexibility, as described in this disclosure.

Moreover, in some examples, when MVD skipping is enabled or disabled or when MVD skipping is not available, the video encoder encodes MVD values. In the techniques described in this disclosure, MVD skipping being enabled or disabled refers to a determination of whether MVD skipping is enabled or disabled. MVD skipping being not available refers to instances where the video encoder and/or the video decoder is not configured to implement MVD skipping. MVD skipping being not available may be similar to MVD skipping being disabled, but without any determination that MVD skipping is disabled. Accordingly, the techniques described in this disclosure are directed to both examples where the video encoder and video decoder are configured to implement MVD skipping (e.g., MVD skipping is available) and MVD skipping can be enabled or disabled, as well as examples where the video encoder and/or video decoder are not configured to implement MVD skipping (e.g., MVD skipping is not available).

For a block that is bi-predicted with two motion vectors, there may be two MVDs, one for each motion vector. Accordingly, the video encoder encodes, and the video decoder decodes, the values for both of the MVDs. Each of the MVDs includes an x-component and a y-component. The video encoder encodes the value of the x-component and the value of y-component to encode each of the values of the MVDs. Similarly, the video decoder decodes the value of the x-component and the value of the y-component to decode each of the values of the MVDs.

When MVD skipping is disabled or when MVD skipping is not available, the video encoder utilizes a first context model for at least one of the bins needed for binarizing the MVD when the motion vector refers to a picture in the first reference picture list, and a second, different context model for at least one of the bins needed for binarizing the MVD when the motion vector refers to a picture in the second reference picture list. The video decoder utilizes the first and second context models for decoding the MVDs for respective motion vectors based on whether the MVD is for the motion vector that refers to a picture in the first reference picture list or is for the motion vector that refers to a picture in the second reference picture list.

For example, in the techniques described in this disclosure, more than one separated context can be used for an MVD of a motion vector from the first and second reference lists. For instance, the MVD may be represented by a plurality of bits, and each of the bits may be considered as a bin. Each MVD bin from the first reference picture list may each have own context models, and each MVD bin from the second reference picture list may each have another context models. Alternatively, this context separation can be done only for the first MVD bins, and starting from the second MVD bin context models can be shared between the first and second reference lists. These techniques of using different context models are described in more detail below.

Utilizing these different context models for the MVDs for the different reference picture lists is also applicable to examples where the MVD is zero, but MVD skipping is disabled or MVD skipping is not available. For example, even when MVD skipping is disabled or not available, it is possible for the MVD for one of the motion vectors to be zero and for another one of the motion vectors to be zero or non-zero. In this case, the video encoder may still code the MVD value of zero, and may utilize the different context models as described above.

For example, if the MVD for the motion vector that refers to a picture in the first reference picture list is zero, and the MVD for the motion vector that refers to a picture in the second reference picture list is non-zero, the video encoder may utilize the first context model to encode the MVD value of zero, and utilize the second, different context model to encode the non-zero MVD value. The video decoder utilizes the first context model to decode the MVD value of zero, and the second, different context model to decode the non-zero MVD value.

Also, when MVD skipping is enabled, the video encoder may not signal the MVD value of zero for one of the motion vectors, but signals the non-zero MVD value for the other motion vector. In this case, for the non-zero MVD value, the video encoder utilizes the first context model if the MVD is for the motion vector that refers to a picture in the first reference picture list, and the second context model if the MVD is for the motion vector that refers to a picture in the second reference picture list.

In the above example, the video encoder may signal the value of zero for the MVD whose value is zero. However, signaling the value of zero is not necessary in every example. In examples where MVD skipping is disabled or not available, rather than signaling the zero value, in some examples, the video encoder may signal a zero MVD flag that indicates that the MVD value is zero, thereby avoiding the coding of a value of zero. For example, if the zero MVD flag is equal to one, then the video decoder determines that both the x-component and the y-component of the MVD are equal to zero. The x-component of the MVD indicates the residual between the x-component of the motion vector predictor and the x-component of the actual motion vector, and the y-component indicates the residual between the y-component of the motion vector predictor and the y-component of the actual motion vector. In some examples, rather than the video encoder signaling the zero MVD flag, the video decoder may infer the value of the zero MVD flag based on the manner in which neighboring or proximate blocks to the current block are predicted.

If the zero MVD flag is equal to zero, the video decoder determines that at least one of the x-component and y-component of the MVD is not equal to zero. For instance, when the zero MVD flag is equal to zero, both the x-component and y-component of the MVD are non-zero values, the x-component of the MVD is a non-zero value and the y-component of the MVD is zero, or the x-component of the MVD is zero and the y-component of the MVD is non-zero.

When the zero MVD flag is equal to zero and the x-component of the MVD is zero, after the video decoder decodes the zero value of the x-component of the MVD, the video decoder determines that the y-component of the MVD is a non-zero value (e.g., the MVD value is one or greater) because the zero MVD flag is equal to zero. In other words, if the zero MVD flag is equal to zero, then at least one of the x-component and y-component of the MVD is a non-zero value. If the x-component of the MVD is equal to zero, then the y-component of the MVD is the component whose value is non-zero. In this case, the video encoder may signal a reduced y-component value. For example, the video encoder may signal the actual y-component value minus one. Because the y-component value is reduced, the video encoder utilizes fewer bits for signaling as compared to signaling the full y-component value. In this example, the video decoder decodes the signaled value, and adds one to the signaled value to determine the y-component value for the MVD.

When the zero MVD flag is equal to zero and the y-component of the MVD is zero, the video encoder may first code the y-component value, which is zero in this case. After the video decoder decodes the y-component value, the video decoder may determine that, because the y-component value is zero, the x-component is a non-zero value (i.e., because the zero MVD flag is equal to zero). In this example, similar to above, the video encoder may signal a reduced value for the x-component (e.g., the actual x-component value minus one) to reduce the number of bits that need to be signaled. The video decoder may determine the actual value of the x-component by adding one to the signaled value of the x-component.

In the example of the zero MVD flag, the video encoder may utilize different context models similar to that described above (e.g., based on whether the MVD is for a motion vector that refers to a picture in a first reference picture list or for a motion vector that refers to a picture in a second reference picture list). The video decoder may similarly use different context models for decoding the MVDs.

By utilizing the different context models for different reference picture lists for coding (e.g., encoding or decoding), the techniques described in this disclosure exploit the statistical differences between MVDs for motion vectors that refer to pictures in the first reference picture list and those that refer to pictures in the second reference picture list. This may result in more efficient coding of the MVDs as compared to other techniques (i.e., techniques that are not in accordance with the techniques described in this disclosure) where the video encoder and video decoder share the context models for the first and second reference picture lists. These other techniques, which use the same context for each list, fail to account for the statistical difference in the MVDs for motion vectors that refer to pictures in different reference picture lists, which may result in inefficient coding of the MVDs. Selecting one or more first context models representing statistical probabilities for MVDs for a first reference picture list, and selecting one or more second context model representing different statistical probabilities for MVDs for a second reference pictures list, may promote more efficient coding. Accordingly, the techniques described in this disclosure may provide for more efficient encoding and decoding of MVDs as compared to some other techniques.

The above example techniques describe utilizing different context models for MVD bins associated with the different reference picture lists. In some examples, the video encoder and the video decoder may initialize context state values for these different context models using the same initialization values. For instance, the above examples described this case where a block is bi-predicted. In some examples, a block is uni-predicted (e.g., predicted with respect to a picture in one of the two reference picture lists, but not in both).

The context models for the first and second reference picture lists for uni-predicted blocks may be the same, and in some cases, may be the same as one of the context models for the first and second reference picture lists for bi-predicted blocks. In some examples, the initial context values for the context models for each of the first and second reference picture lists for a bi-predicted block may be same as the initial context values for the context model of the reference picture list for a uni-predicted block.

In some examples, the initial context values for the context models for one of the first and second reference picture lists for a bi-predicted block may be the same as the initial context values for the context model of the reference picture list for uni-predicted block. In these examples, the initial context values for the context models for the other one of the first and second reference picture lists for a bi-predicted block may be different than the initial context values for the context model of the reference picture list for uni-predicted block. As another example, the initial context values for the context models for the first and second reference picture lists for the bi-predicted block may be the same, and different than the initial context values for the content model of the reference picture list for the uni-predicted block.

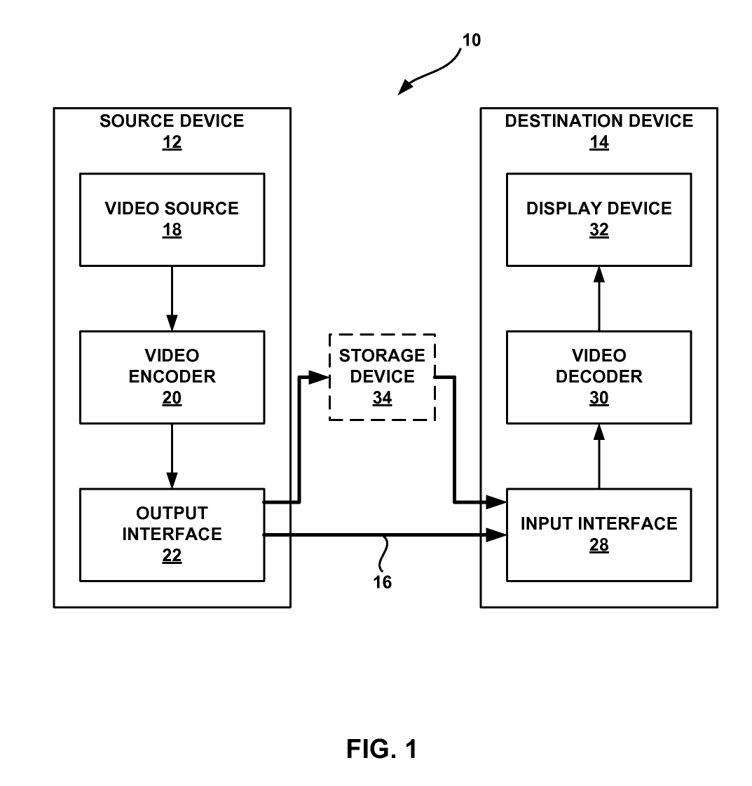

FIG. 1 is a block diagram illustrating an example video encoding and decoding system 10 that may utilize the techniques described in this disclosure. As shown in FIG. 1, system 10 includes a source device 12 that generates encoded video data to be decoded at a later time by a destination device 14. Source device 12 and destination device 14 may comprise any of a wide range of devices, including desktop computers, notebook (i.e., laptop) computers, tablet computers, set-top boxes, telephone handsets such as so-called “smart” phones, so-called “smart” pads, televisions, cameras, display devices, digital media players, video gaming consoles, video streaming device, or the like. In some cases, source device 12 and destination device 14 may be equipped for wireless communication.

Destination device 14 may receive the encoded video data to be decoded via a link 16. Link 16 may comprise any type of medium or device capable of moving the encoded video data from source device 12 to destination device 14. In one example, link 16 may comprise a communication medium to enable source device 12 to transmit encoded video data directly to destination device 14 in real-time. The encoded video data may be modulated according to a communication standard, such as a wireless communication protocol, and transmitted to destination device 14. The communication medium may comprise any wireless or wired communication medium, such as a radio frequency (RF) spectrum or one or more physical transmission lines. The communication medium may form part of a packet-based network, such as a local area network, a wide-area network, or a global network such as the Internet. The communication medium may include routers, switches, base stations, or any other equipment that may be useful to facilitate communication from source device 12 to destination device 14.

Alternatively, encoded data may be output from output interface 22 to a storage device 34. Similarly, encoded data may be accessed from storage device 34 by input interface. Storage device 34 may include any of a variety of distributed or locally accessed data storage media such as a hard drive, Blu-ray discs, DVDs, CD-ROMs, flash memory, volatile or non-volatile memory, or any other suitable digital storage media for storing encoded video data. In a further example, storage device 34 may correspond to a file server or another intermediate storage device that may hold the encoded video generated by source device 12. Destination device 14 may access stored video data from storage device 34 via streaming or download. The file server may be any type of server capable of storing encoded video data and transmitting that encoded video data to the destination device 14. Example file servers include a web server (e.g., for a website), an FTP server, network attached storage (NAS) devices, or a local disk drive. Destination device 14 may access the encoded video data through any standard data connection, including an Internet connection. This may include a wireless channel (e.g., a Wi-Fi connection), a wired connection (e.g., DSL, cable modem, etc.), or a combination of both that is suitable for accessing encoded video data stored on a file server. The transmission of encoded video data from storage device 34 may be a streaming transmission, a download transmission, or a combination of both.

The techniques of this disclosure are not necessarily limited to wireless applications or settings. The techniques may be applied to video coding in support of any of a variety of multimedia applications, such as over-the-air television broadcasts, cable television transmissions, satellite television transmissions, streaming video transmissions (e.g., via the Internet), encoding of digital video for storage on a data storage medium, decoding of digital video stored on a data storage medium, or other applications. In some examples, system 10 may be configured to support one-way or two-way video transmission to support applications such as video streaming, video playback, video broadcasting, and/or video telephony.

In the example of FIG. 1, source device 12 includes a video source 18, video encoder 20 and an output interface 22. In some cases, output interface 22 may include a modulator/demodulator (modem) and/or a transmitter. In source device 12, video source 18 may include a source such as a video capture device, e.g., a video camera, a video archive containing previously captured video, a video feed interface to receive video from a video content provider, and/or a computer graphics system for generating computer graphics data as the source video, or a combination of such sources. As one example, if video source 18 is a video camera, source device 12 and destination device 14 may form so-called camera phones or video phones. However, the techniques described in this disclosure may be applicable to video coding in general, and may be applied to wireless and/or wired applications.

The captured, pre-captured, or computer-generated video may be encoded by video encoder 20. The encoded video data may be transmitted directly to destination device 14 via output interface 22 of source device 12. The encoded video data may also (or alternatively) be stored onto storage device 34 for later access by destination device 14 or other devices, for decoding and/or playback.

Destination device 14 includes an input interface 28, a video decoder 30, and a display device 32. In some cases, input interface 28 may include a receiver and/or a modem. Input interface 28 of destination device 14 receives the encoded video data over link 16. The encoded video data communicated over link 16, or provided on storage device 34, may include a variety of syntax elements generated by video encoder 20 for use by a video decoder, such as video decoder 30, in decoding the video data. Such syntax elements may be included with the encoded video data transmitted on a communication medium, stored on a storage medium, or stored a file server.

Display device 32 may be integrated with, or external to, destination device 14. In some examples, destination device 14 may include an integrated display device and also be configured to interface with an external display device. In other examples, destination device 14 may be a display device. In general, display device 32 displays the decoded video data to a user, and may comprise any of a variety of display devices such as a liquid crystal display (LCD), a plasma display, an organic light emitting diode (OLED) display, or another type of display device.

Video encoder 20 and video decoder 30 may operate according to a video compression standard, such as the High Efficiency Video Coding (HEVC) standard presently under development, and may conform to the HEVC Test Model (HM). A recent Working Draft (WD) of HEVC, and referred to as HEVC WD9 hereinafter, is available, as of Dec. 29, 2012, from http://phenix.int-evry.fr/jct/doc_end_user/documents/11_Shanghai/wg11/JCTVC-K1003-v10.zip. Alternatively, video encoder 20 and video decoder 30 may operate according to other proprietary or industry standards, such as the ITU-T H.264 standard, alternatively referred to as MPEG-4, Part 10, Advanced Video Coding (AVC), or extensions of such standards. Other examples of video compression standards include MPEG-2 and ITU-T H.263.

The techniques of this disclosure, however, are not limited to any particular coding standard. Moreover, even if the techniques described in this disclosure may not necessarily conform to a particular standard, the techniques described in this disclosure may further assist in coding efficiency relative to the various standards. Also, the techniques described in this disclosure may be part of future standards. For ease of understanding, the techniques are described with respect to the HEVC standard under development, but the techniques are not limited to the HEVC standard, and can be extended to other video coding standards or video coding techniques that are not defined by a particular standard.

Although not shown in FIG. 1, in some aspects, video encoder 20 and video decoder 30 may each be integrated with an audio encoder and decoder, and may include appropriate MUX-DEMUX units, or other hardware and software, to handle encoding of both audio and video in a common data stream or separate data streams. If applicable, in some examples, MUX-DEMUX units may conform to the ITU H.223 multiplexer protocol, or other protocols such as the user datagram protocol (UDP).

Video encoder 20 and video decoder 30 each may be implemented as any of a variety of suitable encoder circuitry, such as one or more microprocessors, digital signal processors (DSPs), application specific integrated circuits (ASICs), field programmable gate arrays (FPGAs), discrete logic, software, hardware, firmware or any combinations thereof. When the techniques are implemented partially in software, a device may store instructions for the software in a suitable, computer-readable storage medium such as a non-transitory computer-readable storage medium and execute the instructions in hardware using one or more processors to perform the techniques of this disclosure. Each of video encoder 20 and video decoder 30 may be included in one or more encoders or decoders, either of which may be integrated as part of a combined encoder/decoder (CODEC) in a respective device.

The Joint Collaborative Team on Video Coding (JCT-VC) is working on development of the HEVC standard. The HEVC standardization efforts are based on an evolving model of a video coding device referred to as the HEVC Test Model (HM). The HM presumes several additional capabilities of video coding devices relative to existing devices according to (e.g., ITU-T H.264/AVC). For example, whereas H.264 provides nine intra-prediction encoding modes, the HM may provide as many as thirty-three intra-prediction encoding modes.

In general, the working model of the HM describes that a video frame or picture may be divided into a sequence of treeblocks or largest coding units (LCU) that include both luma and chroma samples. A treeblock has a similar purpose as a macroblock of the H.264 standard. A slice includes a number of consecutive treeblocks in coding order. A video frame or picture may be partitioned into one or more slices. Each treeblock may be split into coding units (CUs) according to a quadtree. For example, a treeblock, as a root node of the quadtree, may be split into four child nodes, and each child node may in turn be a parent node and be split into another four child nodes. A final, unsplit child node, as a leaf node of the quadtree, comprises a coding node, i.e., a coded video block. Syntax data associated with a coded bitstream may define a maximum number of times a treeblock may be split, and may also define a minimum size of the coding nodes.

A CU includes a coding node and prediction units (PUs) and transform units (TUs) associated with the coding node. A size of the CU corresponds to a size of the coding node and may be square in shape. The size of the CU may range from 8×8 pixels up to the size of the treeblock with a maximum of 64×64 pixels or greater. Each CU may contain one or more PUs and one or more TUs. Syntax data associated with a CU may describe, for example, partitioning of the CU into one or more PUs. Partitioning modes may differ between whether the CU is skip or direct mode encoded, intra-prediction mode encoded, or inter-prediction mode encoded. PUs may be partitioned to be non-square in shape. Syntax data associated with a CU may also describe, for example, partitioning of the CU into one or more TUs according to a quadtree. A TU can be square or non-square in shape.

The HEVC standard allows for transformations according to TUs, which may be different for different CUs. The TUs are typically sized based on the size of PUs within a given CU defined for a partitioned LCU, although this may not always be the case. The TUs are typically the same size or smaller than the PUs. In some examples, residual samples corresponding to a CU may be subdivided into smaller units using a quadtree structure known as “residual quad tree” (RQT). The leaf nodes of the RQT may be referred to as transform units (TUs). Pixel difference values associated with the TUs may be transformed to produce transform coefficients, which may be quantized.

In general, a PU includes data related to the prediction process. For example, when the PU is intra-mode encoded (i.e., intra-predicted), the PU may include data describing an intra-prediction mode for the PU. As another example, when the PU is inter-mode encoded (i.e., inter-predicted), the PU may include data defining a motion vector for the PU. The data defining the motion vector for a PU may describe, for example, a horizontal component of the motion vector, a vertical component of the motion vector, a resolution for the motion vector (e.g., one-quarter pixel precision or one-eighth pixel precision), a reference picture to which the motion vector points, and/or a reference picture list (e.g., List 0 (L0) or List 1 (L1)) for the motion vector.

In some examples, List 0 identifies pictures that are displayed earlier than the current picture, and List 1 identifies pictures that are displayed later than the current picture. However, such a requirement of the pictures identified in List 0 and List 1 is not necessary in every example. For instance, List 0 may identify some pictures that are displayed earlier than the current picture and some picture that are displayed later than the current picture. List 1 may similarly identify pictures that are displayed earlier and later relative to the current picture.

In general, a TU is used for the transform and quantization processes. A given CU having one or more PUs may also include one or more transform units (TUs). Following prediction, video encoder 20 may calculate residual values corresponding to the PU. The residual values comprise pixel difference values that may be transformed into transform coefficients, quantized, and scanned using the TUs to produce serialized transform coefficients for entropy coding. This disclosure typically uses the term “video block” to refer to a coding node of a CU. In some specific cases, this disclosure may also use the term “video block” to refer to a treeblock, i.e., LCU, or a CU, which includes a coding node and PUs and TUs.

For example, for video coding according to the high efficiency video coding (HEVC) standard currently under development, a video picture may be partitioned into coding units (CUs), prediction units (PUs), and transform units (TUs). A CU generally refers to an image region that serves as a basic unit to which various coding tools are applied for video compression. A CU typically has a square geometry, and may be considered to be similar to a so-called “macroblock” under other video coding standards, such as, for example, ITU-T H.264.

To achieve better coding efficiency, a CU may have a variable size depending on the video data it contains. That is, a CU may be partitioned, or “split” into smaller blocks, or sub-CUs, each of which may also be referred to as a CU. In addition, each CU that is not split into sub-CUs may be further partitioned into one or more PUs and TUs for purposes of prediction and transform of the CU, respectively.

PUs may be considered to be similar to so-called partitions of a block under other video coding standards, such as H.264. PUs are the basis on which prediction for the block is performed to produce “residual” coefficients. Residual coefficients of a CU represent a difference between video data of the CU and predicted data for the CU determined using one or more PUs of the CU. Specifically, the one or more PUs specify how the CU is partitioned for the purpose of prediction, and which prediction mode is used to predict the video data contained within each partition of the CU.

One or more TUs of a CU specify partitions of a block of residual coefficients of the CU on the basis of which a transform is applied to the block to produce a block of residual transform coefficients for the CU. The one or more TUs may also be associated with the type of transform that is applied. The transform converts the residual coefficients from a pixel, or spatial domain to a transform domain, such as a frequency domain. In addition, the one or more TUs may specify parameters on the basis of which quantization is applied to the resulting block of residual transform coefficients to produce a block of quantized residual transform coefficients. The residual transform coefficients may be quantized to possibly reduce the amount of data used to represent the coefficients.

A CU generally includes one luminance component, denoted as Y, and two chrominance components, denoted as U and V. In other words, a given CU that is not further split into sub-CUs may include Y, U, and V components, each of which may be further partitioned into one or more PUs and TUs for purposes of prediction and transform of the CU, as previously described. For example, depending on the video sampling format, the size of the U and V components, in terms of a number of samples, may be the same as or different than the size of the Y component. As such, the techniques described above with reference to prediction, transform, and quantization may be performed for each of the Y, U, and V components of a given CU.

To encode a CU, one or more predictors for the CU are first derived based on one or more PUs of the CU. A predictor is a reference block that contains predicted data for the CU, and is derived on the basis of a corresponding PU for the CU, as previously described. For example, the PU indicates a partition of the CU for which predicted data is to be determined, and a prediction mode used to determine the predicted data. The predictor can be derived either through intra-(I) prediction (i.e., spatial prediction) or inter-(P or B) prediction (i.e., temporal prediction) modes. Hence, some CUs may be intra-coded (I) (i.e., intra-predicted) using spatial prediction with respect to neighboring reference blocks, or CUs, in the same picture, while other CUs may be inter-coded (P or B) (i.e., inter-predicted) with respect to reference blocks, or CUs, in other pictures.

Upon identification of the one or more predictors based on the one or more PUs of the CU, a difference between the original video data of the CU corresponding to the one or more PUs and the predicted data for the CU contained in the one or more predictors is calculated. This difference, also referred to as a prediction residual, comprises residual coefficients, and refers to pixel differences between portions of the CU specified by the one or more PUs and the one or more predictors, as previously described. The residual coefficients are generally arranged in a two-dimensional (2-D) array that corresponds to the one or more PUs of the CU.

To achieve further compression, the prediction residual is generally transformed (e.g., using a discrete cosine transform (DCT), integer transform, Karhunen-Loeve (K-L) transform, or another transform). The transform converts the prediction residual (i.e., the residual coefficients) in the spatial domain to residual transform coefficients in the transform domain (e.g., a frequency domain). The transform coefficients are also generally arranged in a 2-D array that corresponds to the one or more TUs of the CU. For further compression, the residual transform coefficients may be quantized to possibly reduce the amount of data used to represent the coefficients, as also previously described.

To achieve still further compression, an entropy coder subsequently encodes the resulting residual transform coefficients, using Context Adaptive Variable Length Coding (CAVLC), Context Adaptive Binary Arithmetic Coding (CABAC), Probability Interval Partitioning Entropy Coding (PIPE), or another entropy coding methodology. Entropy coding may achieve this further compression by reducing or removing statistical redundancy inherent in the video data of the CU, represented by the coefficients, relative to other CUs.

A video sequence typically includes a series of video frames or pictures. A group of pictures (GOP) generally comprises a series of one or more of the video pictures. A GOP may include syntax data in a header of the GOP, a header of one or more of the pictures, or elsewhere, that describes a number of pictures included in the GOP. Each slice of a picture may include slice syntax data that describes an encoding mode for the respective slice. Video encoder 20 typically operates on video blocks within individual video slices in order to encode the video data. A video block may correspond to a coding node within a CU. The video blocks may have fixed or varying sizes, and may differ in size according to a specified coding standard.

As an example, the HM supports prediction in various PU sizes. Assuming that the size of a particular CU is 2N×2N, the HM supports intra-prediction in PU sizes of 2N×2N or N×N, and inter-prediction in symmetric PU sizes of 2N×2N, 2N×N, N×2N, or N×N. The HM also supports asymmetric partitioning for inter-prediction in PU sizes of 2N×nU, 2N×nD, nL×2N, and nR×2N. In asymmetric partitioning, one direction of a CU is not partitioned, while the other direction is partitioned into 25% and 75%. The portion of the CU corresponding to the 25% partition is indicated by an “n” followed by an indication of “Up”, “Down,” “Left,” or “Right.” Thus, for example, “2N×nU” refers to a 2N×2N CU that is partitioned horizontally with a 2N×0.5N PU on top and a 2N×1.5N PU on bottom.

In this disclosure, “N×N” and “N by N” may be used interchangeably to refer to the pixel dimensions of a video block in terms of vertical and horizontal dimensions (e.g., 16×16 pixels or 16 by 16 pixels). In general, a 16×16 block will have 16 pixels in a vertical direction (y=16) and 16 pixels in a horizontal direction (x=16). Likewise, an N×N block generally has N pixels in a vertical direction and N pixels in a horizontal direction, where N represents a nonnegative integer value. The pixels in a block may be arranged in rows and columns. Moreover, blocks need not necessarily have the same number of pixels in the horizontal direction as in the vertical direction. For example, blocks may comprise N×M pixels, where M is not necessarily equal to N.

Following intra-predictive or inter-predictive coding using the PUs of a CU, video encoder 20 may calculate residual data for the TUs of the CU. The PUs may comprise pixel data in the spatial domain (also referred to as the pixel domain) and the TUs may comprise coefficients in the transform domain following application of a transform, e.g., a discrete cosine transform (DCT), an integer transform, a wavelet transform, or a conceptually similar transform to residual video data. The residual data may correspond to pixel differences between pixels of the unencoded picture and prediction values corresponding to the PUs. Video encoder 20 may form the TUs including the residual data for the CU, and then transform the TUs to produce transform coefficients for the CU.

Following any transforms to produce transform coefficients, video encoder 20 may perform quantization of the transform coefficients. Quantization generally refers to a process in which transform coefficients are quantized to possibly reduce the amount of data used to represent the coefficients, providing further compression. The quantization process may reduce the bit depth associated with some or all of the coefficients. For example, an n-bit value may be rounded down to an m-bit value during quantization, where n is greater than m.

In some examples, video encoder 20 may utilize a predefined scan order to scan the quantized transform coefficients to produce a serialized vector that can be entropy encoded. In other examples, video encoder 20 may perform an adaptive scan. After scanning the quantized transform coefficients to form a one-dimensional vector, video encoder 20 may entropy encode the one-dimensional vector (e.g., according to context adaptive variable length coding (CAVLC), context adaptive binary arithmetic coding (CABAC), syntax-based context-adaptive binary arithmetic coding (SBAC), Probability Interval Partitioning Entropy (PIPE) coding or another entropy encoding methodology). Video encoder 20 may also entropy encode syntax elements associated with the encoded video data for use by video decoder 30 in decoding the video data.

To perform CABAC, video encoder 20 may assign a context within a context model to a symbol or one or more bins of a binarized representation of the symbol to be transmitted. The context may relate to, for example, whether values of the symbol for neighboring transform coefficients are non-zero or not. To perform CAVLC, video encoder 20 may select a variable length code for a symbol to be transmitted. Codewords in VLC may be constructed such that relatively shorter codes correspond to more probable symbols, while longer codes correspond to less probable symbols. In this way, the use of VLC may achieve a bit savings over, for example, using equal-length codewords for each symbol to be transmitted. The probability determination may be based on a context assigned to the symbol.

Video encoder 20 and video decoder 30 may be configured to implement techniques in accordance with this disclosure. For example, as described above, an inter-predicted block is predicted with respect to a block of a reference picture. The location of the block in the reference picture is identified by a motion vector. In some examples, video encoder 20 signals the motion vector information (e.g., the x- and y-components of the motion vector) that video decoder 30 utilizes to identify the block that is used to inter-predict a current block. However, signaling the motion vector information of the motion vector of the current block is not necessary in every example.

For instance, video encoder 20 defines a motion vector prediction mode in which video encoder 20 signals information that indicates a motion vector predictor, and video decoder 30 utilizes the motion vector predictor to determine the motion vector for the current block. Examples of the motion vector prediction mode include the merge/skip mode and the advanced motion vector prediction (AMVP) mode.

A motion vector predictor is a motion vector for a previously coded block (i.e., a motion vector for a block other than the block that is being inter-predicted). In both the merge/skip mode and the AMVP mode, video decoder 30 constructs a list of candidate motion vector predictors based on motion vectors of blocks that spatially and/or temporally neighbor the current block (i.e., the block being inter-predicted). Spatially neighboring blocks are blocks that reside within the same picture as the current block, and temporally neighboring blocks are blocks that reside within a different picture than the picture that includes the current block.

As one example, for spatially neighboring blocks, video decoder 30 determines whether the block that is located at the bottom-left of the current block, at the top-left of the current block, at the top-right of the current block, and located to the left of the block located at the top-right of the current block are inter-predicted with one or more motion vectors (i.e., inter-predicted with respect to one or two reference pictures). Video decoder 30 includes the motion vectors for these neighboring blocks that are inter-predicted in the list of candidate motion vector predictors.

For temporally neighboring blocks, video decoder 30 determines whether a co-located block in another picture is inter-predicted, and, if inter-predicted, includes the motion vector for the co-located block in the list of candidate motion vector predictors. The co-located block may encompass the same region in the picture that the current block encompasses in its picture or may encompass a larger or smaller region in the picture than the region that the current block encompasses in its picture. In some examples, the co-located block is located to the bottom-right of the block that encompasses the same region in the picture that the current block encompasses in its picture.

The motion vectors that video decoder 30 determines for inclusion in the list of candidate motion vector predictors may be different for the merge/skip mode and the AVMP mode. Also, in some examples, after constructing the list of candidate motion vector predictors, video decoder 30 implements a pruning process to remove one or more candidates from the list of candidate motion vector predictors (e.g., based on redundancy of the candidates).

In general, there may be various ways in which video decoder 30 constructs the list of candidate motion vector predictors, and the above techniques are one example way in which video decoder 30 may construct the list of candidate motion vector predictors. The techniques described in this disclosure are not limited to any particular technique for constructing the list of candidate motion vector predictors.

Also, although the construction of the list of candidate motion vector predictors is described with respect to video decoder 30, video encoder 20 may implement substantially similar techniques to construct a list of candidate motion vector predictors on the video encoder 20 side. For example, video encoder 20 signals an index into the list of candidate motion vector predictors that video decoder 30 constructed. For video encoder 20 to determine the index into the list of candidate motion vector predictors that video decoder 30 constructed, video encoder 20 may construct an identical list of candidate motion vector predictors utilizing similar techniques as video decoder 30.

Video decoder 30 receives the index into the constructed list of candidate motion vector predictors that video decoder 30 is to use for determining the motion vector of the current block. For example, video decoder 30 selects the motion vector predictor identified by the index into the list of candidate motion vector predictors.

For merge/skip mode, video decoder 30 adopts the selected motion vector as the motion vector for the current block. In other words, video decoder 30 sets the motion vector for the current block equal to the motion vector predictor. Also, for merge/skip mode, video decoder 30 inherits the reference picture to which the motion vector predictor referred. For example, the motion vector predictor referred to a reference picture, and video decoder 30 refers to the same reference picture as identified in the reference picture list for inter-predicting the current block.

In the AMVP mode, similar to the merge/skip mode, video decoder 30 selects the motion vector predictor identified by the index into the candidate list of motion vector predictors. In addition, video decoder 30 receives a motion vector difference (MVD) between the motion vector predictor and the actual motion vector of the current block. The MVD may be considered as a residual between the motion vector predictor and the actual motion vector, and video encoder 20 signals this residual. Video decoder 30 adds or subtracts the residual to the selected motion vector predictor to determine the motion vector for the current block.

Also, in the AMVP mode, video decoder 30 receives an index into at least one reference picture list that identifies the reference picture that video decoder 30 is to use for inter-predicting the current block. As described above, in merge/skip mode, video decoder 30 utilizes the reference picture to which the motion vector predictor referred for inter-predicting the current block. In the AMVP mode, video decoder 30 may not necessarily utilize the same reference picture to which the motion vector predictor referred for inter-predicting the current block. Rather, video decoder 30 utilizes the reference picture identified by an index into the reference picture list to determine the block that is to be used for inter-predicting the current block.

For example, as part of the decoding process, video decoder 30 constructs one or two reference picture lists referred to as List 0 and List 1. For a block that is bi-predicted, the block is predicted with respect to a block in a picture identified in List 0 and a block in a picture identified in List 1. For a block that is uni-predicted, the block is predicted with respect to a block in a picture identified in List 0 or a block in a picture identified in List 1. For a bi-predicted block, a first motion vector identifies the location of the block in the picture identified in List 0, and a second motion vector identifies the location of the block in the picture identified in List 1. For a uni-predicted block, one motion vector identifies the location of the block in the picture identified in List 0 or the block in the picture identified in List 1. In general, for the uni-predicted block, the motion vector identifies a picture located in List 0; however, the techniques described in this disclosure are not so limited.

In AMVP mode, for a bi-predicted block there may be two MVDs. A first MVD indicates the difference between a first selected motion vector predictor and the first motion vector. A second MVD indicates the difference between a second selected motion vector predictor and the second motion vector. In this case, video decoder 30 receives the first MVD and the second MVD from video encoder 20, adds or subtracts the first selected motion vector predictor with the first MVD to determine the first motion vector, and adds or subtracts the second selected motion vector predictor with the second MVD to determine the second motion vector.

Video decoder 30 also receives two reference index values, one for each of the two MVDs. In some examples, the order in which video decoder 30 receives the two reference index values determines to which reference picture list the reference index values refer.

For example, video decoder 30 receives the first MVD value and the first reference index value, and then receives the second MVD value and the second reference index value. In this case, video decoder 30 determines that the first reference index value is for List 0, and the second reference index value is for List 1. For instance, video decoder 30 determines whether the reference index value is for List 0 or List 1 based on the order in which video decoder 30 receives the reference index values. Video decoder 30 utilizes the determined first motion vector, the picture identified in List 0 by the first reference index value, the determined second motion vector, and the picture identified in List 1 by the second reference value to inter-predict the current block (i.e., reconstruct the current block).

In AMVP mode, for a uni-predicted block, there is one MVD that video encoder 20 signals to video decoder 30, along with a reference index value and an indication as to whether the reference index value is for List 0 or List 1. In this example, video decoder 30 adds or subtracts the selected motion vector predictor with the MVD to determine the motion vector for the current block. Video decoder 30 utilizes the determined motion vector, the indicated reference picture list (e.g., List 0 or List 1) and the picture identified by the reference index value to inter-predict the current block (i.e., reconstruct the current block).

In some instances, the MVD between the motion vector predictor and the actual motion vector is zero. The techniques described in this disclosure describe various example implementations that video encoder 20 and video decoder 30 may implement to flexibly indicate when the MVD is zero. As one example, video encoder 20 and video decoder 30 may implement MVD skipping in which video encoder 20 determines that the MVD for pictures identified in List 0, List 1, or in both List 0 and List 1 is zero. Also, video encoder 20 may determine whether the MVD for pictures identified in List 0, List 1, or in both List 0 and List 1, is equal to zero for all blocks in a picture, for all blocks in a slice, or for a particular block. In these examples, video decoder 30 may not receive the zero value for the MVDs for pictures in List 0, List 1, or both List 0 and List 1 for which video encoder 20 determined that MVD skipping is enabled. In examples where video encoder 20 and video decoder 30 are configured to implement MVD skipping, video encoder 20 and video decoder 30 may be configured to determine whether MVD skipping is enabled or disabled for a particular reference picture list.

In some cases, MVD skipping may be disabled or video encoder 20 and video decoder 30 may not be configured to implement MVD skipping. In examples where video encoder 20 and video decoder 30 are not configured to implement MVD skipping, MVD skipping may be considered as being not available. However, when MVD skipping is disabled or when MVD skipping is not available, it may be possible for video encoder 20 to determine that MVDs for pictures in one or both of the reference picture lists is generally zero.

For these examples, video encoder 20 may utilize different context models for encoding an MVD for a motion vector that refers to a picture in List 0 and an MVD for a motion vector that refers to a picture in List 1. Video decoder 30 may utilize these same context models (i.e., one for the MVD for the motion vector that refers to a picture in List 0, and a different one for the MVD for the motion vector that refers to a picture in List 1) to decode the MVDs for pictures in List 0 and List 1.

Moreover, video encoder 20 and video decoder 30 may utilize these different context models for encoding or decoding MVDs for motion vectors that refer to pictures in List 0 and List 1, even in examples where the MVDs for pictures in List 0 or List 1 are not generally zero. Also, even in examples where MVD skipping is enabled for one of the reference picture lists, video encoder 20 may still signal an MVD for a motion vector for a picture in the other reference picture list. Video encoder 20 may select one of the two different context models for encoding the MVD for the motion vector based on the reference picture list that includes the picture to which the motion vector refers. Video decoder 30 may similarly select one of the two different context models for decoding the MVD for the motion vector based on the reference picture list that includes the picture to which the motion vector refers.

In the above example of using different context models, video encoder 20 may still signal the zero value for an MVD whose value is zero, and video decoder 30 may receive the zero value for the MVD. However, this is not required in all examples; in some examples, when MVD skipping is disabled or MVD skipping is not available, video encoder 20 may signal a zero MVD flag. If the zero MVD flag is one, then video decoder 30 may determine that both the x-component and y-component of the MVD is equal to zero. In this case, video encoder 20 may not need to signal and video decoder 30 may not need to receive the zero value for the MVD whose value is zero. If the zero MVD flag is zero, then video decoder 30 may determine at least one of the x-component and y-component is a non-zero value.

Accordingly, the techniques described in this disclosure related to the coding of MVDs are described with examples related to MVD skipping, with examples related to context modeling, and examples related to a flag that indicates whether the value of the MVD is zero or non-zero (i.e., the zero MVD flag). Each of these examples is described in turn for ease of illustration and understanding. However, it should be understood that although these techniques are described separately, aspects of this disclosure are not so limited. In some examples, video encoder 20 and video decoder 30 may implement these techniques separately. In some examples, video encoder 20 and video decoder 30 may implement two or more of these techniques in conjunction with one another.

For instance, in some examples, video encoder 20 and video decoder 30 may implement the examples related to MVD skipping, context modeling, and the zero MVD flag together. In some examples, video encoder 20 and video decoder 30 may implement the examples related to MVD skipping, context modeling, and the zero MVD flag separately. In some examples, video encoder 20 and video decoder 30 may implement the examples related to any two of MVD skipping, context modeling, and the zero MVD flag (i.e., MVD skipping and context modeling, MVD skipping and zero MVD flag, or context modeling and zero MVD flag). In some examples, video encoder 20 and video decoder 30 may implement only one of MVD skipping, context modeling, and the zero MVD flag.

For MVD skipping, video encoder 20 and video decoder 30 each construct one or both of List 0 and List 1, at the beginning of coding of a picture. Video encoder 20 may determine that for each inter-predicted block in the picture, if the MVD for the motion vector for each inter-predicted block refers to a picture in List 0, the MVD for that motion vector is equal to zero. Alternatively, video encoder 20 may determine that for each inter-predicted block in the picture, if the MVD for the motion vector for each inter-predicted block refers to a picture in List 1, the MVD for that motion vector is equal to zero. As another example, video encoder 20 may determine that for each inter-predicted block in the picture, if the MVD for the motion vector for each inter-predicted block refers to a picture in either List 0 or List 1, the MVD for that motion vector is equal to zero.

In these examples, video encoder 20 may signal an MVD skipping mode to video decoder 30 that indicates that MVD skipping is enabled for the picture, and that indicates whether MVD skipping is enabled with respect to List 0, List 1, or both List 0 and List 1. For blocks within the picture that are inter-predicted with the AMVP mode, if the reference index refers to a picture in the reference picture list for which MVD skipping is enabled, video decoder 30 may not receive the MVD value, and may set the motion vector for that block equal to the selected motion vector predictor.

As an illustrative example, assume that video encoder 20 signaled that MVD skipping is enabled for List 0. In this case, assume that in AMVP mode, a block in the picture is uni-predicted with respect to a picture in List 0. In this example, video decoder 30 receives an index into the candidate list of motion vector predictors, an indication that the reference picture list is List 0, and a reference index value into List 0. However, video decoder 30 does not receive the MVD. Instead, video decoder 30 selects the motion vector predictor from the index into the candidate list of motion vector predictors, and sets the motion vector of the block equal to the motion vector predictor (i.e., determines that the MVD is zero).

As another illustrative example, assume that video encoder 20 signaled that MVD skipping is enabled for List 1. In this case, assume that in AMVP mode, a block in the picture is bi-predicted with respect to one picture in List 0 and one picture in List 1. In this example, video decoder 30 receives an index into the list of candidate motion vector predictors (to identify the two motion vectors for the bi-predicted block), an MVD for the motion vector that refers to a picture in List 0, a reference index value into List 0, and a reference index value into List 1, but not an MVD for the motion vector that refers to a picture in List 1.

Video decoder 30 utilizes the index into the list of candidate motion vector predictors to select a first motion vector predictor and to select a second motion vector predictor. For the motion vector that refers to the picture in List 0, video decoder 30 adds or subtracts the first motion vector predictor with the received MVD to determine the motion vector for the picture in the List 0.

In this example, video decoder 30 does not receive the MVD for the motion vector that refers to the picture in List 1. Instead, video decoder 30 sets the second motion vector predictor equal to the motion vector that refers to the picture in List 1.

The above examples describe techniques for a uni-predicted block where MVD skipping is enabled for a List 0 and for a bi-predicted block where MVD skipping is enabled for List 1. Video encoder 20 and video decoder 30 may implement similar techniques for examples where the block is uni-predicted and MVD skipping is enabled for List 1, and for examples where the block is bi-predicted and MVD skipping is enabled for List 0.

In some examples, MVD skipping is enabled for both List 0 and List 1. In these examples, video encoder 20 does not signal any MVDs. For a uni-predicted block, video decoder 30 sets the selected motion vector predictor equal to motion vector for the block. For a bi-predicted block, video decoder 30 sets the first selected motion vector predictor equal to the first motion vector for the block, and sets the second selected motion vector predictor equal to the second motion vector for the block.

Also, in the above examples, video encoder 20 enabled MVD skipping for List 0, List 1, or both List 0 and List 1 for all of the blocks within the picture. However, the MVD skipping techniques are not so limited. In some other examples, video encoder 20 may enable MVD skipping for List 0, List 1, or both List 0 and List 1, for all blocks within a slice of a picture. For instance, a picture may include a plurality of slices, and each slice may include a plurality of blocks.

Video encoder 20 and video decoder 30 may be configured to implement MVD skipping at a slice level, rather than at a picture level. For instance, video encoder 20 enables MVD skipping for List 0 for all blocks within a first slice of the picture, enables MVD skipping for List 1 for all blocks within a second slice of the picture, and enables MVD skipping for List 0 and List 1 for all blocks within a third slice of the picture.

In some examples, video encoder 20 and video decoder 30 may be configured to implement the MVD skipping at a block level, rather than a slice or picture level. For instance, for a first block, video encoder 20 may indicate that for the first block, MVD skipping is enabled for List 0, for List 1, or for both List 0 and List 1. Then, for a second block, even if the second block is in the same slice as the first block, video encoder 20 may indicate that for the second block, MVD skipping is enabled for a different list than the list for the first block, or MVD skipping is enabled for the same list or lists as the first block.

In this manner, the MVD skipping techniques described in this disclosure provide for functional flexibility in implementing MVD skipping. For example, video encoder 20 and video decoder 30 may implement MVD skipping for either List 0 or List 1, or for both List 0 and List 1. Also, video encoder 20 and video decoder 30 may implement MVD skipping at a picture level, slice level, or block level. Such functional flexibility may result in more efficient coding of the MVD. For instance, if better coding can be realized by enabling MVD skipping for List 0 and not for List 1, video encoder 20 and video decoder 30 can selectively enable MVD skipping for List 0 and not for List 1. Similarly, if better coding can be realized by enabling MVD skipping for List 1 and not for List 0 or for both List 0 and List 1, video encoder 20 and video decoder 30 can selectively enable MVD skipping for List 1 and not for List 0 or for both List 0 and List 1.

Also, if better coding can be realized by enabling MVD skipping for List 0 for all blocks in one picture and for List 1 for all blocks in another picture, video encoder 20 and video decoder 30 may selectively enable MVD skipping for List 0 for one picture and List 1 for the other picture. Similarly, if better coding can be realized by enabling MVD skipping for List 0 for all blocks within a slice of a picture and for List 0 for all blocks within another slice of the same picture, video encoder 20 and video decoder 30 may selectively enable MVD skipping for List 0 for one slice within the picture and List 1 for another slice within the same picture. The same may be applied at a block level. Also, the same may be applied for instances where better coding is realized if both List 0 and List 1 are skipped at the picture level, slice level, or block level.

In some other techniques that are not in accordance with the MVD skipping techniques described in this disclosure, a video encoder may be configured to limit MVD skipping only for List 1, only at a picture level, and only for bi-predicted blocks.

In these cases, when MVD skipping is enabled, even if better coding can be realized by enabling MVD skipping for List 0 for blocks within a slice of the picture, the video encoder and video decoder may not be configured to implement such MVD skipping. In other words, in these other techniques, the limitation that MVD skipping is only enabled for List 1, only at a picture level (e.g., applied to all blocks in the picture), and only for bi-predicted blocks may result in the video encoder and video decoder utilizing MVD skipping when MVD skipping does not necessarily provide coding efficiency, as well as not allowing MVD skipping for certain cases where coding efficiency can be realized.

There may be various ways in which video encoder 20 and video decoder 30 determine whether MVD skipping is enabled for List 0, List 1, or both List 0 and List 1, and whether MVD skipping is enabled at the picture level, slice level, or block level. As one example, video encoder 20 signals an MVD_mode flag syntax element to video decoder 30. If the MVD_mode flag is one, then video decoder 30 determines that MVD skipping is enabled. If the MVD_mode flag is zero, then video decoder 30 determines that MVD skipping is disabled. In addition, video encoder 20 may signal an MVD_skipping flag syntax element that indicates whether MVD skipping is enabled for List 0 or enabled for List 1. For example, if the MVD_mode flag is one and MVD_skipping flag is zero, then video decoder 30 determines that MVD skipping is enabled for List 0. If the MVD_mode flag is zero and MVD_skipping flag is one, then video decoder 30 determines that MVD skipping is enabled for List 1.

As another example, rather than an MVD_skipping flag, video encoder 20 may signal two bits in an MVD_skipping_idc syntax element. In this example, if MVD_mode flag is one and MVD_skipping_idc equals 00, then video decoder 30 determines that MVD skipping is enabled for List 0. If MVD_mode flag is one and MVD_skipping_idc equals 11, then video decoder 30 determines that MVD skipping is enabled for List 1. If MVD_mode flag is one and MVD_skipping_idc equals 01 or 10, then video decoder 30 determines that MVD skipping is enabled for both List 0 and List 1.

Video encoder 20 may signal the MVD_mode flag, the MVD_skipping flag, and the MVD_skipping_idc at different levels. For instance, as described above, video encoder 20 and video decoder 30 may enable MVD skipping at a picture level, slice level, and block level. In some examples, video encoder 20 may signal the MVD_mode flag in a picture header to indicate that MVD is enabled or disabled for all blocks within the picture. As another example, video encoder 20 may signal the MVD_mode flag in a slice header to indicate that MVD is enabled or disabled for all blocks with the slice. Alternatively, video encoder 20 may signal the MVD_mode flag in the PU, CU, LCU or other group of blocks level to indicate that MVD is enabled or disabled at a block level. In some examples, video encoder 20 may signal the MVD_mode flag in the sequence parameter set (SPS), picture parameter set (PPS), or the adaption parameter set (APS).

Video encoder 20 may signal the MVD_skipping flag or the MVD_skipping_idc at the same levels as the MVD_mode flag or at different levels. For example, video encoder 20 may signal the MVD_skipping flag and the MVD_skipping_idc in the picture header, slice header, in the PU, CU, LCU, or other group of blocks level, SPS, PPS, or APS. In some examples, video encoder 20 may signal the MVD_skipping mode together with the MVD_skipping flag or MVD_skipping_idc. In some examples, video encoder 20 may separately signal the MVD_skipping mode and the MVD_skipping flag or MVD_skipping_idc.

Also, although MVD skipping is described as being enabled at the block level, in some instances, enabling MVD skipping at the block level may be bandwidth inefficient. For instance, in some examples, video encoder 20 may signal the MVD_mode flag and the MVD_skipping flag or the MVD_skipping_idc at the PU, CU, or LCU level. Because there may be a substantial number of blocks within a picture, signaling the MVD_mode flag and the MVD_skipping flag or MVD_skipping_idc at the block level may consume more bandwidth than desired. Accordingly, in some examples, the MVD skipping may be enabled at the picture level or slice level.

The values for MVD_mode flag, MVD_skipping flag, MVD_skipping_idc are provided for purposes of illustration only and should not be considered limiting. In general, in some examples, video encoder 20 may signal a first syntax element that indicates whether MVD skipping is enabled, and may signal a second syntax element that indicates whether MVD skipping is enabled for List 0, List 1, or both List 0 and List 1.

Moreover, signaling both the MVD_mode flag and the MVD_skipping flag or MVD_skipping_idc is not necessary in every example. As one example, video encoder 20 may only signal the MVD_skipping flag, and not signal the MVD_mode flag. In this example, if MVD_skipping flag is one (e.g., true), video decoder 30 determines that MVD skipping is enabled, and is enabled for List 0. Alternatively, if MVD_skipping flag is one, video decoder 30 determines that MVD skipping is enabled, and is enabled for List 1.

As another example, video encoder 20 may signal only the MVD_skipping_idc, and not signal the MVD_mode flag. In this example, the first bit of the MVD_skipping_idc indicates whether MVD skipping is enabled or disabled, and the second bit of the MVD_skipping_idc indicates whether MVD skipping is enabled for List 0 or List 1. For example, if MVD_skipping_idc is 00 or 01, video decoder 30 determines that MVD skipping is disabled. If MVD_skipping_idc is 10, video decoder 30 determines that MVD skipping is enabled for List 0. If MVD_skipping_idc is 11, video decoder 30 determines that MVD skipping is enabled for List 1.

In some examples, rather than the first bit of the MVD_skipping_idc indicating whether MVD skipping is enabled or disabled, the codeword formed by MVD_skipping_idc may indicate whether MVD skipping is enabled or disabled, and if enabled, whether MVD skipping is enabled for List 0, List 1, or both List 0 and List 1. For example, if MVD_skipping_idc is 00, then video decoder 30 may determine that MVD skipping is disabled. If MVD_skipping_idc is 01, then video decoder 30 may determine that MVD skipping is enabled for List 0. If MVD_skipping_idc is 10, then video decoder 30 may determine that MVD skipping is enabled for List 1. If MVD_skipping_idc is 11, then video decoder 30 may determine that MVD skipping is enabled for List 0 and List 1. Again, the specific values for MVD_skipping_idc that indicate whether MVD is enabled for List 0, List 1, or both List 0 and List 1 is provided for purposes of illustration and should not be considered limiting.

Moreover, video encoder 20 need not necessarily signal syntax elements to video decoder 30 to indicate whether MVD skipping is enabled. In some examples, video decoder 30 is configured to derive or infer whether MVD skipping is enabled without necessarily receiving syntax elements from video encoder 20 indicating as such. Furthermore, video decoder 30 may be configured to derive or infer whether MVD skipping is enabled for List 0, List 1, or both List 0 and List 1, and enabled at the picture level, slice level, or block level. In this manner, video decoder 30 may be configured to determine whether MVD skipping is enabled and enabled at the picture level, slice level, or block level based on received syntax elements or by deriving or inferring.

For example, video decoder 30 determines the MVDs for blocks that neighbor or are proximate to the current block being inter-predicted. If the MVDs for the blocks that neighbor or are proximate to the current block are close to zero, then video decoder 30 determines that MVD skipping is enabled for the block. Examples of the neighboring blocks includes blocks located on the corners of the current block, as well as blocks located to the left, right, top, or bottom of the current block. As one example, video decoder 30 may be configured with a threshold value or the threshold value may be signaled by video encoder 20. If the number of neighboring or proximate blocks whose MVD values are approximately zero is greater than or equal to the threshold value, then video decoder 30 determines that MVD skipping is enabled for the current block that is to be inter-predicted.

Video decoder 30 may apply similar techniques to determine whether MVD skipping is enabled at the slice level or picture level. For example, if the number of neighboring or proximate blocks whose MVD values are approximately zero is greater than or equal to a first threshold value, then video decoder 30 determines that MVD skipping is enabled for all blocks within the current picture. If the number of neighboring or proximate blocks whose MVD values are approximately zero is greater than or equal to a second threshold value, but less than the first threshold value, then video decoder 30 determines that MVD skipping is enabled for all blocks within the current slice. If the number of neighboring or proximate blocks whose MVD values are approximately zero is greater than or equal to a third threshold value, but less than the second threshold value, then video decoder 30 determines that MVD skipping is enabled for the current block.

Video encoder 20 may signal the values of the first, second, and third threshold values. Alternatively, video decoder 30 may be pre-configured with the values of the first, second, and third threshold values. Using the first, second, and third threshold values to determine whether MVD skipping is enabled at a picture level, slice level, or block level is provided for purposes of illustration and should not be considered limiting. There may be other ways in which video decoder 30 infers whether MVD skipping is enabled, and whether MVD skipping is enabled at the picture level, slice level, or the block level without receiving signaling that indicates whether MVD skipping is enabled and whether MVD skipping is enabled at the picture level, slice level, or block level.

As described above, video encoder 20 signals the MVD between the motion vector predictor and the actual motion vector. To signal the MVD, video encoder 20 encodes the MVD. It should be understood that in this disclosure when the MVD is described as being encoded or decoded that each component of the MVD is being encoded or decoded. For example, as described above, the MVD includes an x-component (MVD_{X}) and a y-component (MVD_{y}). When video encoder 20 encodes an MVD, video encoder 20 may be considered as encoding each of the MVD components (i.e., MVD_{X} and MVD_{y}). Similarly, when video decoder 30 decodes an MVD, video decoder 30 may be considered as decoding each of the MVD components (i.e., MVD_{X} and MVD_{y}). For ease of description, the techniques are described with encoding and decoding an MVD with the understanding that such encoding and decoding applies for each component of the MVD.

Also, as described above, to encode the MVD, video encoder 20 may utilize context adaptive binary arithmetic coding (CABAC). In CABAC, video encoder 20 binarizes the MVD into binary bits (i.e., bins). For example, video encoder 20 determines a codeword for a particular value of the MVD. Video encoder 20 may determine the codeword based on a pre-stored coding table, where the coding table maps a codeword to a particular MVD value. The determined codeword may include a plurality of bits, and the location of each bit in the codeword represents one bin. Because video encoder 20 determines the codeword based on the mapping defined by the coding table, an MVD whose value is zero may be binarized into a plurality of bits. As noted above, the determining of the codeword for the MVD applies to each of the x-component and y-component, but for purposes of illustration such determining of the codeword for the x-component and y-component of the MVD is generally described as determining a codeword for the MVD.

Video encoder 20 then selects contexts for one or more bins to determine probability estimates for the bins of the MVD values according to a context model. For instance, the context model defines contexts, and the contexts define context state values. The context state values correspond to the probability of a bin being zero or one. In this example, video decoder 20 may apply a CABAC coding process to arithmetically encode one or more of the bins based on probability estimates for the bins. In some examples, video encoder 20 may select contexts for the first two bins of the binarized MVD value, and bypass encode the remaining bins of the binarized MVD value.

When MVD skipping is disabled or not available, it may be possible that the MVD values for the motion vector(s) that refer to picture(s) in one of List 0 or List 1 or both List 0 and List 1 are zero. When MVD skipping is disabled or not available, even if the MVD values for the motion vector(s) that refer to picture(s) in List 0 or List 1 or both List 0 and List 1 are zero, video encoder 20 may signal the zero MVD value. For instance, when MVD skipping is enabled, video encoder 20 may not signal the MVD value of zero. When MVD skipping is disabled or not available, and the MVD values for the motion vector(s) that refer to picture(s) in one of List 0 or List 1 or both List 0 and List 1 is zero, video encoder 20 may signal the zero MVD value.

In such a situation, the statistical properties of the MVD values for the motion vectors that refer to pictures in List 0 and the MVD values for the motion vectors that refer to pictures in List 1 may be different. For example, assume that the values of MVDs for the motion vectors for all blocks in a slice that refer to pictures in List 0 are zero, and that the values of MVDs for the motion vectors of one or more blocks in the slice that refer to pictures in List 1 are non-zero. In this case, the statistical properties of the MVDs for motion vectors that refer to pictures in List 0 will be different than the statistical properties of the MVDs for motion vectors that refer to pictures in List 1 (e.g., in terms of probabilities of particular bin values). In other words, when the MVDs for one of the reference picture lists are generally zero, it can be assumed that MVDs have different statistical properties for List 0 and List 1.

Video encoder 20 and video decoder 30 may exploit the unbalanced statistical properties of the MVDs for motion vectors that refer to pictures in List 0 and for motion vectors that refer to pictures in List 1. For example, as described above, for CABAC, video encoder 20 utilizes a context model for CABAC coding of bins for the MVD values. In some examples, video encoder 20 utilizes a first context model to determine the probability of a value of at least one bin of the MVDs for the motion vectors that refer to pictures in List 0, and utilizes a second, different context model to determine the probability of a value of at least one bin of the MVDs for the motion vectors that refer to pictures in List 1.

There may be a plurality of bins for the MVDs for motion vectors that refer to pictures in List 0 and a plurality of bins for the MVDs for motion vectors that refer to pictures in List 1. Video encoder 20 may utilize different context models for at least one bin of the MVDs for motion vectors that refer to pictures in List 0 and for at least one bin of the MVDs for motion vectors that refer to pictures in List 1. Each context model, also referred to as a context, defines a probability model for values of a symbol. In general, video encoder 20 may encode each bin or group of bins for the codeword that corresponds to the MVD value using separate context models based on whether the MVD value is for a motion vector that refers to a picture in List 0 or for a motion vector that refers to a picture in List 1. Hence, a given bin of an MVD value for a motion vector that refers to a picture in List 0 may be CABAC-coded using a different context than the context that is used to CABAC-code a corresponding bin of an MVD value for a motion vector that refers to a picture in List 1. Again, the different context models may be selected in recognition that the MVD values for motion vectors associated with the different lists (List 0 and List 1) may have different statistical probabilities.

For example, utilizing different context models means that the context models are not shared to code those bins that use the different context models. In this way, the context state or probabilities of each context model is updated according the MVD bins for the MVD for the motion vector that refers to a picture in List 0, and separately updated for the MVD bins for the MVD for the motion vector that refers to a picture in List 1. Such separate updating is different than some other techniques in which context states or probabilities are updated jointly using MVD bins for MVD for the motion vector that refers to a picture in either List 0 or List 1 (i.e., other techniques that use the same context models, rather than different context models, as described in this disclosure).

As one example, video encoder 20 may utilize the first context model for CABAC coding of a first bin of the plurality of bins for the MVDs for motion vectors that refer to pictures in List 0 and utilize the second context model for CABAC coding of a first bin of the plurality of bins for the MVDs for motion vectors that refer to pictures in List 1. As another example, video encoder 20 may utilize the first context model for a second bin of the plurality of bins for the MVDs for motion vectors that refer to pictures List 0 and utilize the second context model for a second bin of the plurality of bins for the MVDs for motion vectors that refer to pictures in List 1. As yet another example, video encoder 20 may utilize the first context model for the first and second bins of the MVDs that refer to pictures in List 0, and utilize the second context model for the first and second bins of the MVDs that refer to pictures in List 1.

For the other bins for the MVDs for motion vectors that refer to pictures in List 0 and in List 1, video encoder 20 may utilize the same context model for CABAC coding for these remaining bins. The same context model for the remaining bins may be the first context model, the second context model, or a third, different context model. As another example, video encoder 20 may encode the remaining bins in bypass mode. In bypass mode, video encoder 20 may not utilize the CABAC techniques for encoding the bins, and may utilize other coding techniques such as Golomb, Golomb-Rice, or exponential Golomb coding, as examples.

In other words, video encoder 20 may encode at least one of a first bin and a second bin of a plurality of bins of the first MVD value with a first context model, and encode at least one of a first bin and a second bin of a plurality of bins of the second MVD value with a second, different context model. Video encoder 20 may encode the remaining bins of the plurality of bins of the first MVD value and the second MVD value in bypass mode.

In some examples where video encoder 20 encodes the first bin of the plurality of bins of the first MVD value with the first context model, and encodes the first bin of the plurality of bins of the second MVD value with the second, different context model, video encoder 20 may encode the second bin of the plurality of bins of the first MVD value and the second bin of the plurality of bins of the second MVD value with a shared context. In some examples where video encoder 20 encodes the second bin of the plurality of bins of the first MVD value with the first context model, and encodes the second bin of the plurality of bins of the second MVD value with the second, different context model, video encoder 20 may encode the first bin of the plurality of bins of the first MVD value and the first bin of the plurality of bins of the second MVD value with a shared context. In the above examples, the use of the shared context and the bypass mode are not always necessary, and should not be considered limiting.

In some examples, video encoder 20 may encode one or more bins of a plurality of bins of the first MVD value with a first context model, and encode one or more bins of the plurality of bins of the second MVD value with a second, different context model. In these examples, the one or more bins of the plurality of bins of the first MVD value may be considered as a first set of bins of the plurality of bins of the first MVD value. The one or more bins of the plurality of bins of the second MVD value may be considered as a second set of bins of the plurality of bins of the second MVD value.

As one example, video encoder 20 may further encode a second set of bins of the plurality of bins of the first MVD value and a second set of bins of the plurality of bins of the second MVD value with a shared context. As another example, video encoder 20 may encode a second set of bins of the plurality of bins of the first MVD value and a second set of bins of the plurality of bins of the second MVD value in bypass mode.

As yet another example, video encoder 20 may encode a first bin of the first MVD value with a first context model, and encode a first bin of the second MVD value with a second, different context model. Video encoder 20 may also encode a second bin of the first MVD value and the second MVD value with a shared context. In this example, video encoder 20 may encode remaining bins (i.e., third bin and additional bins) of the first MVD value and the second value in bypass mode. Other such permutations and combinations may be possible, and are consistent with the techniques described in this disclosure.

Video decoder 30 may implement the inverse of the encoding technique that video encoder 20 utilized to encode the MVDs. For example, video decoder 30 may receive a bin of a CABAC encoded MVD value (i.e., a codeword that corresponds to the MVD value). Video decoder 30 may determine whether the MVD value is for a motion vector that refers to a picture in List 0 or a motion vector that refers to a picture in List 1. If video decoder 30 determines that the motion vector refers to a picture in List 0, then video decoder 30 utilizes the first context model to CABAC decode the MVD value. If video decoder 30 determines that the motion vector refers to a picture in List 1, then video decoder 30 utilizes the second context model to CABAC decode the MVD value. Video decoder 30 may utilize the coding table to determine the MVD value based on the decoded value. For example, video decoder 30 utilizes the first or second context model to determine a codeword for the MVD value. Video decoder 30 utilizes the coding table to determine the mapping between the codeword and the actual MVD value.

Although the above techniques are described with respect to CABAC, the techniques described in this disclosure are not so limited. The techniques described in this disclosure may be extendable to other coding techniques such as adaptive variable length coding (CAVLC), syntax-based context-adaptive binary arithmetic coding (SBAC), Probability Interval Partitioning Entropy (PIPE) coding or another entropy encoding methodology.

In accordance with the above examples of context models, for a bi-predicted block, video encoder 20 may utilize a first context model to encode one or more bins of the MVD value for the motion vector that refers to a picture in List 0, and may utilize a second context model to encode one or more bins of the MVD value for the motion vector that refers to a picture in List 1. For a uni-predicted block, there is only one motion vector, and therefore, only one MVD. In general, the probability for the MVD of the uni-predicted block to be zero is low (i.e., the MVD value for the motion vector that refers to a picture in one of List 0 or List 1 for uni-predicted blocks are less likely to be dominated by a zero value).

Because the MVD values for uni-predicted blocks are less likely to be dominated by a zero value, in some examples, video encoder 20 may utilize a third context model to CABAC encode bins of the MVD value for a uni-predicted block, where the MVD value is for a motion vector that refers to a picture in List 0. Video encoder 20 may utilize a fourth context model to CABAC encode bins of the MVD value for a uni-predicted block, where the MVD value is for a motion vector that refers to a picture in List 1. In these examples, the first context model for a bi-predicted block, the second context model for a bi-predicted block, the third context model for a uni-predicted block, and the fourth context model for a uni-predicted block may all be different context models. Accordingly, in this example, there may be a total of four context models for encoding the MVDs (two for bi-predicted blocks and two for uni-predicted blocks).

In some examples, rather than video encoder 20 utilizing four context models, video encoder 20 may share some of the context models. For example, video encoder 20 may utilize the first and second context models for bi-predicted blocks, and utilize one context model, rather that two context models, for uni-predicted blocks. In this case, video encoder 20 utilizes three context models for encoding the MVDs.

It may be possible to further reduce the number of context models for encoding the MVDs. For example, video encoder 20 may utilize the first and second context models for encoding MVDs for the bi-predicted blocks. In this example, video encoder 20 may utilize one of the first and second context models as the context model for the uni-predicted block. In this case, there may be two context models for encoding MVDs (i.e., two for MVDs of bi-predicted blocks, and one for MVDs of uni-predicted blocks, where the context model for the MVDs for uni-predicted blocks is the same as one of the context models for the MVDs for the bi-predicted block).

As one example, for the MVD for a motion vector of a uni-predicted block that refers to a picture in List 0 or List 1, video encoder 20 may utilize the first context model to encode the MVD. In this example, video encoder 20 utilizes the first context model to encode the MVD for a motion vector of a bi-predicted block that refers to a picture in List 0 and utilizes the first context model to encode the MVD for a motion vector of a uni-predicted block that refers to a picture in either List 0 or List 1. In this example, video encoder 20 utilizes the second context model to encode the MVD for a motion vector of a bi-predicted block that refers to a picture in List 1.

As another example, for the MVD for a motion vector of a uni-predicted block that refers to a picture in List 0 or List 1, video encoder 20 may utilize the second context model to encode the MVD. In this example, video encoder 20 utilizes the second context model to encode the MVD for a motion vector of a bi-predicted block that refers to a picture in List 1 and utilizes the second context model to encode the MVD for a motion vector of a uni-predicted block that refers to a picture in either List 0 or List 1. In this example, video encoder 20 utilizes the first context model to encode the MVD for a motion vector of a bi-predicted block that refers to a picture in List 0.

In some examples, video encoder 20 may determine whether the context model for the MVDs for uni-predicted blocks should be the same as the first context model for MVDs for bi-predicted blocks or the same as the second context model for MVDs for bi-predicted blocks based on the number of MVDs whose value is zero for motion vectors that refer to pictures in List 0 or refer to pictures in List 1. For instance, video encoder 20 may share context models for MVDs of uni-predicted blocks with the context model for MVDs of bi-predicted blocks for the reference picture list with fewer MVDs with zero value.

As one example, assume that MVD values for motion vectors that refer to pictures in List 1 are more biased towards zero. In this example, video encoder 20 may utilize the first context model to encode the MVDs for motion vectors of bi-predicted blocks that refer to pictures in List 0 and utilize the first context model to encode the MVDs for motion vectors of uni-predicted blocks that refer to pictures in List 0 or in List 1. Video encoder 20 may utilize the second context model to encode the MVDs for motion vectors of bi-predicted blocks that refer to pictures in List 1.

As another example, assume that MVD values for motion vectors that refer to pictures in List 0 are more biased towards zero. In this example, video encoder 20 may utilize the second context model to encode the MVDs for motion vectors of bi-predicted blocks that refer to pictures in List 1 and utilize the second context model to encode the MVDs for motion vectors of uni-predicted blocks that refer to pictures in List 0 or in List 1. Video encoder 20 may utilize the first context model to encode the MVDs for motion vectors of bi-predicted blocks that refer to pictures in List 0.

Again, video decoder 30 utilizes similar techniques to decode the MVD values as the techniques that video encoder 20 utilizes to encode the MVD values. In examples where video encoder 20 selects which context model to use for encoding MVDs for uni-predicted blocks based on the MVD values for motion vectors that refer to List 0 and List 1, video encoder 20 may signal syntax elements to video decoder 30 identifying the reference picture list whose MVD values are more biased towards zero. In this manner, video decoder 30 may determine which context model to use for decoding MVDs for uni-predicted blocks.

In some examples, rather than receiving syntax elements that identify the reference picture list whose MVD values are more biased towards zero, video decoder 30 may infer the reference picture list whose MVD values are more biased towards zero based on coding conditions or configurations. For example, video decoder 30 may store the MVD value statistics from previously decoded MVD values, and determine whether previously decoded MVD values are biased towards zero for a particular reference picture list. In these examples, video decoder 30 need not necessarily receive signaling identifying the reference picture list whose MVD values are more biased toward zero, and may be configured to determine which context model to utilize for decoding MVDs for uni-predicted blocks without receiving such signaling.

To utilize the different context models for encoding and decoding, video encoder 20 and video decoder 30 may be configured to initialize context state values for the context models. These initial context state values define the initial probability estimates. As the probability estimates change due to the encoding or decoding of bins, video encoder 20 and video decoder 30 update the context state values.

In some examples, video encoder 20 and video decoder 30 may initialize the context state values for the first and second context models (e.g., those for MVDs of bi-predicted blocks) using the same context state values as the context model for the uni-predicted blocks. As another example, video encoder 20 and video decoder 30 may initialize the context state values for the first and second context models using the same values, but use different context state values to initialize the context state values for the context model for the uni-predicted blocks.

As another example, video encoder 20 and video decoder 30 may initialize the context state values for the first context model and the context model for the uni-predicted block using the same context values, and initialize the context state values for the second context model using different context values. As yet another example, video encoder 20 and video decoder 30 may initialize the context state values for the second context model and the context model for the uni-predicted block using the same context values, and initialize the context state values for the first context model using different context values.

As described above, utilizing the different context models for MVDs for motion vectors of bi-predicted blocks that refer to pictures in List 0 and for motion vectors of bi-predicted blocks that refer to pictures in List 0 exploits the statistical unbalance in the MVDs for better coding efficiency. In some other techniques (i.e., those not in accordance with the techniques described in this disclosure), video encoder 20 and video decoder 30 share the same context model for MVDs for motion vectors that refer to pictures in List 0 and for motion vectors that refer to pictures in List 1 for bi-predicted blocks. However, because the context models are the same, it may not be possible to gain coding efficiency when the statistical properties of the MVDs are different. In other words, the limitation that the context models be the same for MVDs of bi-predicted blocks may result in poorer coding results, as compared to utilizing different coding models in the manner described in this disclosure.

In the above examples where MVD skipping is disabled or MVD skipping is not available, video encoder 20 may signal and video decoder 30 may receive the MVD value of zero. However, in instances where MVD skipping is disabled or MVD skipping is not available, signaling the MVD value of zero and receiving the MVD value of zero is not required in every example.

In some examples where MVD skipping is disabled or MVD skipping is not available, rather than encoding the zero value for an MVD, video encoder 20 may signal a zero MVD flag. If the zero MVD flag is true (e.g., a one), then video decoder 30 determines that the MVD for motion vector is zero. If the zero MVD flag is false (e.g., a zero), then video decoder 30 determines that at least one component for the MVD is non-zero.

The zero MVD flag may reduce the overall number of bits that video encoder 20 needs to signal and video decoder 30 needs to receive. For example, if MVDs for motion vectors of bi-predicted blocks that refer to pictures in List 0 are biased towards zero, then, even if video encoder 20 signals the zero MVD flag for all MVDs, a reduction in the number of bits that video encoder 20 signals may be realized because video encoder 20 does not signal the MVD value of zero for the blocks that utilize the pictures in List 0 for inter-prediction.

In some examples, to further reduce the number of bits that video encoder 20 signals and video decoder 30 receives, video encoder 20 may signal the zero MVD flag only for bi-predicted blocks. In these examples, for uni-predicted blocks, even if the MVD value is zero, video encoder 20 may signal the MVD value of zero. Although video encoder 20 signals the MVD value of zero for uni-predicted blocks, the number of bits that video encoder 20 signals may be reduced. For example, in general, the probability that the MVD for a motion vector of a uni-predicted block is zero is relatively low. In this example, signaling the zero MVD flag for each uni-predicted block may consume more bits than signaling the MVD value of zero for the few uni-predicted blocks whose MVD value is zero.

Video encoder 20 may signal the zero MVD flag at the PU, CU, LCU or group of CU level. However, signaling the zero MVD flag at these levels may consume more bandwidth than necessary. For instance, in some examples, video encoder 20 may signal the zero MVD flag in the SPS, PPS, or APS headers.

Video encoder 20 may not signal the zero MVD flag in every example. Rather, video decoder 30 may be configured to infer the value of the zero MVD flag. For example, video decoder 30 may determine the value of the zero MVD flag based on the slice type, inter-prediction direction (e.g., whether predicted from List 0 or List 1), and MVDs of neighboring or proximate blocks to the current block that is to be inter-predicted. As one example, if the MVDs for the neighboring blocks is smaller than a threshold value, video decoder 30 may determine that the zero MVD flag for the current block is equal to one (e.g., true).

In examples where video decoder 30 determines the value of the zero MVD flag (e.g., in examples where video encoder 20 signals the zero MVD flag or examples where video decoder 30 infers the zero MVD flag), if video decoder 30 determines that the zero MVD flag is true, video decoder 30 may set the motion vector for the current block equal to motion vector predictor. In some examples, when the zero MVD flag is zero (e.g., false), it may be possible that at least one of the components of the MVD is zero.

For instance, as described above, the MVD includes an x-component and a y-component. The x-component is the residual of the x-component of the motion vector predictor and the x-component of the actual motion vector. The y-component is the residual of the y-component of the motion vector predictor and the y-component of the actual motion vector. In this example, when the zero MVD flag is one, the MVD equals (0, 0). When the zero MVD flag is zero, the MVD may equal (X, Y), (0, Y), or (X, 0), where X and Y are non-zero values.

If video decoder 30 determines the zero MVD value is zero, and MVD equals (0, Y), after video decoder 30 decodes the zero value for the x-component of the MVD, video decoder 30 may determine that the value of the y-component of the MVD is non-zero. For instance, in this example, the x-component of MVD is zero, and if the y-component of the MVD were also zero, then the zero MVD value would be one. However, because the zero MVD value is zero, and the x-component of the MVD is zero, then the y-component of the MVD cannot be zero.

To reduce the number of bits that video encoder 20 signals, in cases where the x-component value of the MVD is zero, and the y-component of the MVD is non-zero, video encoder 20 may signal a reduced value of the y-component. As one example, video encoder 20 may signal the value of the y-component minus one (i.e., video encoder may signal (0, Y−1)). Video encoder 20 may utilize fewer bits to signal the reduced value of the y-component as compared to signaling the actual value of the y-component.

In this example, after video decoder 30 determines that the value of the x-component of the MVD is zero, video decoder 30 may determine that the value of the y-component is non-zero, and may also determine that the received value is a reduced value of the y-component. For instance, video decoder 30 may determine that the received value is the actual value of the y-component minus one. Video decoder 30 may add one to the received value of the y-component to determine the actual value of the y-component.

In examples where the value of the MVD equals (X, 0), video encoder 20 may signal the value of the y-component first, followed by the value of the x-component. For example, it may be possible to configure video encoder 20 to signal the y-component value first. However, in these examples, rather than signaling the actual value of the x-component, video encoder 20 may signal a reduced value of the x-component (e.g., X−1).

In these examples, video decoder 30 determines that the value of the zero MVD flag is zero. After video decoder 30 determines that the value of y-component is zero, video decoder 30 may determine that the received value for the x-component is the reduced value for the x-component. Video decoder 30 may add one to the received value of the x-component to determine the actual value of the x-component of the MVD.

In examples where video encoder 20 and video decoder 30 utilize the zero MVD flag, video encoder 20 and video decoder 30 may utilize context models in a manner similar to that described above. For example, video encoder 20 and video decoder 30 may each utilize a first context model for MVDs for motion vectors of bi-predicted blocks that refer to pictures in List 0, and utilize a second context model for MVDs for motion vectors of bi-predicted blocks that refer to pictures in List 1. For uni-predicted blocks, video encoder 20 and video decoder 30 may utilize a different context model than the first and second context models, or the context for the uni-predicted block may the same as one of the first context model or the second context model. The initialization of the context models may be similar to that described above, or different from that described above in examples where video encoder 20 and video decoder 30 utilize the zero MVD flag.

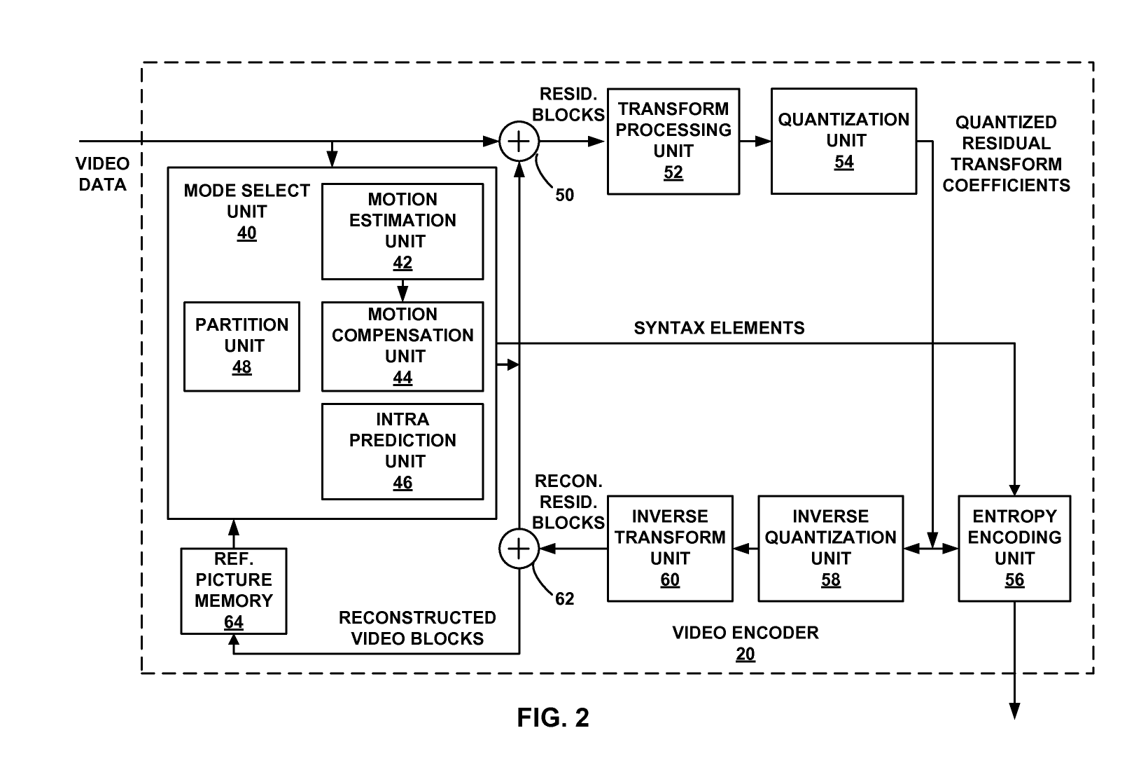

FIG. 2 is a block diagram illustrating an example video encoder 20 that may implement the techniques described in this disclosure. Video encoder 20 may perform intra- and inter-coding of video blocks within video slices. Intra-coding (i.e., intra-predicting) relies on spatial prediction to reduce or remove spatial redundancy in video within a given video frame or picture. Inter-coding (i.e., inter-predicting) relies on temporal prediction to reduce or remove temporal redundancy in video within adjacent frames or pictures of a video sequence. Intra-mode (I mode) may refer to any of several spatial based compression modes. Inter-modes, such as uni-directional prediction (P mode) or bi-prediction (B mode), may refer to any of several temporal-based compression modes.

As shown in FIG. 2, video encoder 20 receives a current video block within a video picture to be encoded. In the example of FIG. 2, video encoder 20 includes mode select unit 40, reference picture memory 64, summer 50, transform processing unit 52, quantization unit 54, and entropy encoding unit 56. Mode select unit 40, in turn, includes motion compensation unit 44, motion estimation unit 42, intra-prediction unit 46, and partition unit 48. For video block reconstruction, video encoder 20 also includes inverse quantization unit 58, inverse transform unit 60, and summer 62. A deblocking filter (not shown in FIG. 2) may also be included to filter block boundaries to remove blockiness artifacts from reconstructed video. If desired, the deblocking filter would typically filter the output of summer 62. Additional filters (in loop or post loop) may also be used in addition to the deblocking filter. Such filters are not shown for brevity, but if desired, may filter the output of summer 50 (as an in-loop filter).

In some examples, mode select unit 40 or mode select unit 40 in conjunction with other units of video encoder 20, may determine that MVD skipping should be enabled and output the syntax for the MVD skipping mode to entropy encoding unit 56 for signaling. For example, mode select unit 40 may output the syntax for the MVD skipping flag or the MVD_skipping_idc, as described above. Mode select unit 40 may also determine the value of the zero MVD flag and output the zero MVD flag, as described above, to entropy encoding unit 56 for signaling. However, aspects of this disclosure are not so limited. In another example, a processor or a processing unit (not specifically illustrated) may determine that MVD skipping should be enabled and output the appropriate syntax for signaling. Similarly, the processor or processing unit may determine that the zero MVD flag should be enabled and output the appropriate syntax for signaling.

Entropy encoding unit 56 may entropy encode the MVDs and the zero MVD flag using the context modeling as described above. For example, entropy encoding unit 56 may utilize the context modeling modification for signaling MVDs, rather than relying on the same context modeling for MVDs for List 0 and List 1 in every example. Similarly, entropy encoding unit 56 may utilize the context modeling for signaling the zero MVD flag, which may reduce the number of bits needed for signaling.

During the encoding process, video encoder 20 receives a video picture or slice to be coded. The picture or slice may be divided into multiple video blocks. Motion estimation unit 42 and motion compensation unit 44 perform inter-predictive coding of the received video block relative to one or more blocks in one or more reference pictures to provide temporal compression. Intra-prediction unit 46 may alternatively perform intra-predictive coding of the received video block relative to one or more neighboring blocks in the same picture or slice as the block to be coded to provide spatial compression. Video encoder 20 may perform multiple coding passes (e.g., to select an appropriate coding mode for each block of video data).

Moreover, partition unit 48 may partition blocks of video data into sub-blocks, based on evaluation of previous partitioning schemes in previous coding passes. For example, partition unit 48 may initially partition a picture or slice into LCUs, and partition each of the LCUs into sub-CUs based on rate-distortion analysis (e.g., rate-distortion optimization). Mode select unit 40 may further produce a quadtree data structure indicative of partitioning of an LCU into sub-CUs. Leaf-node CUs of the quadtree may include one or more PUs and one or more TUs.

Mode select unit 40 may select one of the coding modes, intra or inter (e.g., based on error results), and provides the resulting intra- or inter-coded block to summer 50 to generate residual block data and to summer 62 to reconstruct the encoded block for use as a reference picture. Mode select unit 40 also provides syntax elements, such as motion vectors, intra-mode indicators, partition information, and other such syntax information, to entropy encoding unit 56.

Motion estimation unit 42 may be configured to determine the inter-prediction mode for a video slice according to a predetermined pattern for a video sequence. Motion estimation unit 42 and motion compensation unit 44 may be highly integrated, but are illustrated separately for conceptual purposes. Motion estimation, performed by motion estimation unit 42, is the process of generating motion vectors, which estimate motion for video blocks. A motion vector, for example, may indicate the displacement of a PU of a video block within a current video frame or picture relative to a predictive block within a reference picture. Motion estimation unit 42 may also determine the motion vector predictor to determine the motion vector difference (MVD).

As described above, the motion vector predictor may be the motion vector for a block other than the current block, and may possibly be a motion vector for a neighboring block. Motion estimation unit 42 may also determine the motion vector difference (MVD). For example, motion estimation unit 42 may determine the difference (e.g., the delta of the X-coordinate and the delta of the Y-coordinate) between the motion vector for the current block and the motion vector predictor.

A predictive block is a block that is found to closely match the PU of the video block to be coded in terms of pixel difference, which may be determined by sum of absolute difference (SAD), sum of square difference (SSD), or other difference metrics. In some examples, video encoder 20 may calculate values for sub-integer pixel positions of reference pictures stored in reference picture memory 64. For example, video encoder 20 may interpolate values of one-quarter pixel positions, one-eighth pixel positions, or other fractional pixel positions of the reference picture. Therefore, motion estimation unit 42 may perform a motion search relative to the full pixel positions and fractional pixel positions and output a motion vector with fractional pixel precision.

Motion estimation unit 42 calculates a motion vector for a PU of a video block in an inter-coded slice by comparing the position of the PU to the position of a predictive block of a reference picture. The reference picture may be selected from a first reference picture list (List 0) or a second reference picture list (List 1), each of which identify one or more reference pictures stored in reference picture memory 64. Motion estimation unit 42 sends the calculated motion vector to entropy encoding unit 56 and motion compensation unit 44. Motion estimation unit 42 may also send the calculated motion vector predictor and the MVD to entropy encoding unit 56.

Motion compensation, performed by motion compensation unit 44, may involve fetching or generating the predictive block based on the motion vector determined by motion estimation unit 42. Again, motion estimation unit 42 and motion compensation unit 44 may be functionally integrated, in some examples. Upon receiving the motion vector for the PU of the current video block, motion compensation unit 44 may locate the predictive block to which the motion vector points in one of the reference picture lists. Summer 50 forms a residual video block by subtracting pixel values of the predictive block from the pixel values of the current video block being coded, forming pixel difference values, as discussed below. In general, motion estimation unit 42 performs motion estimation relative to luma components, and motion compensation unit 44 uses motion vectors calculated based on the luma components for both chroma components and luma components. Mode select unit 40 may also generate syntax elements associated with the video blocks and the video slice for use by video decoder 30 in decoding the video blocks of the video slice.

Intra-prediction unit 46 may intra-predict a current block, as an alternative to the inter-prediction performed by motion estimation unit 42 and motion compensation unit 44, as described above. In particular, intra-prediction unit 46 may determine an intra-prediction mode to use to encode a current block. In some examples, intra-prediction unit 46 may encode a current block using various intra-prediction modes, e.g., during separate encoding passes, and intra-prediction unit 46 (or mode select unit 40, in some examples) may select an appropriate intra-prediction mode to use from the tested modes.

For example, intra-prediction unit 46 may calculate rate-distortion values using a rate-distortion analysis for the various tested intra-prediction modes, and select the intra-prediction mode having the best rate-distortion characteristics among the tested modes. Rate-distortion analysis generally determines an amount of distortion (or error) between an encoded block and an original, unencoded block that was encoded to produce the encoded block, as well as a bit rate (that is, a number of bits) used to produce the encoded block. Intra-prediction unit 46 may calculate ratios from the distortions and rates for the various encoded blocks to determine which intra-prediction mode exhibits the best rate-distortion value for the block.

Video encoder 20 forms a residual video block by subtracting the prediction data from mode select unit 40 from the original video block being coded. Summer 50 represents the component or components that perform this subtraction operation. Transform processing unit 52 applies a transform, such as a discrete cosine transform (DCT) or a conceptually similar transform, to the residual block, producing a video block comprising residual transform coefficient values. Transform processing unit 52 may perform other transforms which are conceptually similar to DCT. Wavelet transforms, integer transforms, sub-band transforms or other types of transforms could also be used.

In any case, transform processing unit 52 applies the transform to the residual block, producing a block of residual transform coefficients. The transform may convert the residual information from a pixel value domain to a transform domain, such as a frequency domain. Transform processing unit 52 may send the resulting transform coefficients to quantization unit 54. Quantization unit 54 quantizes the transform coefficients to further reduce bit rate. The quantization process may reduce the bit depth associated with some or all of the coefficients. The degree of quantization may be modified by adjusting a quantization parameter. In some examples, quantization unit 54 may then perform a scan of the matrix including the quantized transform coefficients. Alternatively, entropy encoding unit 56 may perform the scan during entropy coding.

Following quantization, entropy encoding unit 56 entropy encodes the quantized transform coefficients. For example, entropy encoding unit 56 may perform context adaptive variable length coding (CAVLC), context adaptive binary arithmetic coding (CABAC) such as select different context models for MVDs for motion vectors that refer to different reference picture lists, syntax-based context-adaptive binary arithmetic coding (SBAC), probability interval partitioning entropy (PIPE) coding or another entropy encoding methodology or technique. Following the entropy encoding by entropy encoding unit 56, the encoded bitstream may be transmitted to video decoder 30, or archived for later transmission or retrieval by video decoder 30. Entropy encoding unit 56 may also entropy encode the motion vectors and the other syntax elements for the current video slice being coded.

As described above, in some examples, entropy encoding unit 56 and mode select unit 40 may be configured to perform the techniques of this disclosure. However, aspects of this disclosure are not so limited. In other examples, some other unit of video encoder 20, such as a processor, or any other unit of video encoder 20 may be tasked to perform the techniques of this disclosure. Also, in some examples, the techniques of this disclosure may be divided among one or more of the units of video encoder 20.

Inverse quantization unit 58 and inverse transform unit 60 apply inverse quantization and inverse transformation, respectively, to reconstruct the residual block in the pixel domain, e.g., for later use as a reference block. Motion compensation unit 44 may calculate a reference block by adding the residual block to a predictive block of one of the pictures of reference picture memory 64. Motion compensation unit 44 may also apply one or more interpolation filters to the reconstructed residual block to calculate sub-integer pixel values for use in motion estimation. Summer 62 adds the reconstructed residual block to the motion compensated prediction block produced by motion compensation unit 44 to produce a reconstructed video block for storage in reference picture memory 64. The reconstructed video block may be used by motion estimation unit 42 and motion compensation unit 44 as a reference block to inter-code a block in a subsequent video picture.

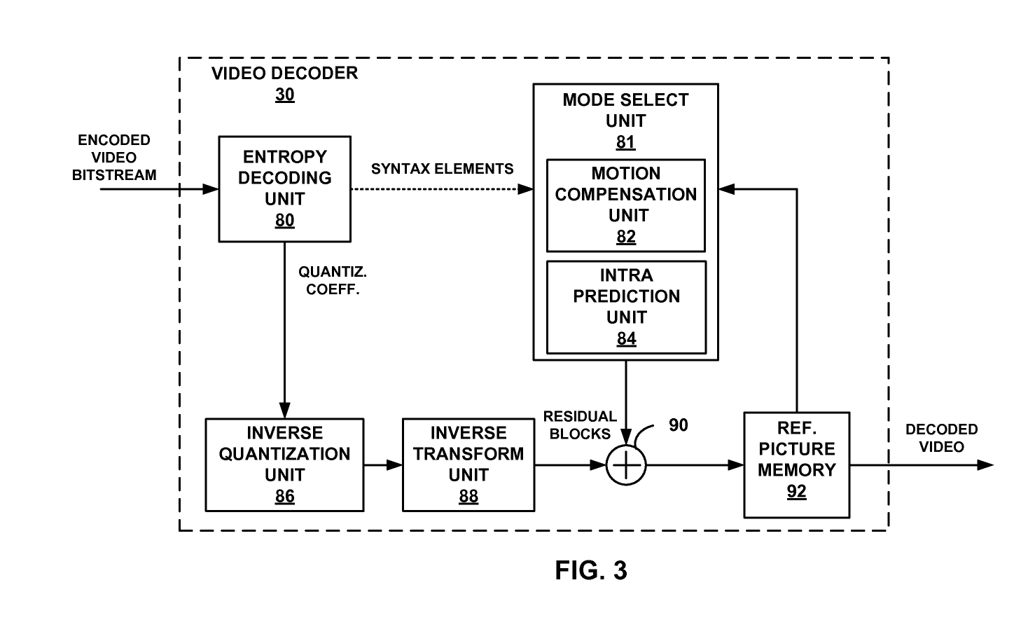

FIG. 3 is a block diagram illustrating an example video decoder 30 that may implement the techniques described in this disclosure. In the example of FIG. 3, video decoder 30 includes an entropy decoding unit 80, mode select unit 81, inverse quantization unit 86, inverse transformation unit 88, summer 90, and reference picture memory 92. Mode select unit 81 includes motion compensation unit 82 and intra prediction unit 84. Video decoder 30 may, in some examples, perform a decoding pass generally reciprocal to the encoding pass described with respect to video encoder 20 from FIG. 2.

In some examples, mode select unit 81 may determine that MVD skipping has been enabled and perform decoding using the motion vector predictor as the motion vector, and without using the MVD to reconstruct the actual motion vector. For example, mode select unit 81 may receive the syntax for the MVD_skipping mode, MVD_skipping flag or the MVD_skipping_idc, as described above. Mode select unit 81 may also receive the value of the zero MVD flag. Mode select unit 81 may decode the current block based on these received flags. In some examples, mode select unit 81 may also identify that MVD skipping is enabled even when explicit flags indicating as such are not received. However, aspects of this disclosure are not so limited. In another example, a processor or a processing unit (not specifically illustrated) may perform such functions of mode select unit 81.

Entropy decoding unit 80 may decode the MVDs and the zero MVD flag using the context modeling as described above. For example, entropy decoding unit 80 may utilize the context modeling modification for decoding MVDs, rather than relying on the same context modeling for MVDs for List 0 and List 1 in every example. Similarly, entropy decoding unit 80 may utilize the context modeling for signaling the zero MVD flag, which may reduce the number of bits that need to be received.

During the decoding process, video decoder 30 receives an encoded video bitstream that represents video blocks of an encoded video slice and associated syntax elements from video encoder 20. Entropy decoding unit 80 of video decoder 30 entropy decodes the bitstream to generate quantized coefficients, motion vectors, and other syntax elements. Entropy decoding unit 80 forwards the motion vectors and other syntax elements to mode select unit 81. Video decoder 30 may receive the syntax elements at the video slice level and/or the video block level.

When the video slice is coded as an intra-coded (I) slice, intra prediction unit 84 of mode select unit 81 may generate prediction data for a video block of the current video slice based on a signaled intra prediction mode and data from previously decoded blocks of the current frame or picture. When the video picture is coded as an inter-coded (i.e., B or P) slice, motion compensation unit 82 of mode select unit 81 produces predictive blocks for a video block of the current video slice based on the motion vectors and other syntax elements received from entropy decoding unit 80. The predictive blocks may be produced from one of the reference pictures within one of the reference picture lists. Video decoder 30 may construct the reference picture lists, List 0 and List 1, using default construction techniques or any other technique based on reference pictures stored in reference picture memory 92.

Motion compensation unit 82 determines prediction information for a video block of the current video slice by parsing the motion vectors and other syntax elements, and uses the prediction information to produce the predictive blocks for the current video block being decoded. For example, motion compensation unit 82 uses some of the received syntax elements to determine a prediction mode (e.g., intra- or inter-prediction) used to code the video blocks of the video slice, an inter-prediction slice type (e.g., B slice or P slice), construction information for one or more of the reference picture lists for the slice, motion vectors for each inter-encoded video block of the slice, inter-prediction status for each inter-coded video block of the slice, and other information to decode the video blocks in the current video slice.

Motion compensation unit 82 may also perform interpolation based on interpolation filters. Motion compensation unit 82 may use interpolation filters as used by video encoder 20 during encoding of the video blocks to calculate interpolated values for sub-integer pixels of reference blocks. In this case, motion compensation unit 82 may determine the interpolation filters used by video encoder 20 from the received syntax elements and use the interpolation filters to produce predictive blocks.

Inverse quantization unit 86 inverse quantizes (i.e., de-quantizes), the quantized transform coefficients provided in the bitstream and decoded by entropy decoding unit 80. The inverse quantization process may include use of a quantization parameter calculated by video encoder 20 for each video block in the video slice to determine a degree of quantization and, likewise, a degree of inverse quantization that should be applied. Inverse transform unit 88 applies an inverse transform, e.g., an inverse DCT, an inverse integer transform, or a conceptually similar inverse transform process, to the transform coefficients in order to produce residual blocks in the pixel domain.

After motion compensation unit 82 generates the predictive block for the current video block based on the motion vectors and other syntax elements, video decoder 30 forms a decoded video block by summing the residual blocks from inverse transform unit 88 with the corresponding predictive blocks generated by motion compensation unit 82. Summer 90 represents the component or components that perform this summation operation. If desired, a deblocking filter may also be applied to filter the decoded blocks in order to remove blockiness artifacts. Other loop filters (either in the coding loop or after the coding loop) may also be used to smooth pixel transitions, or otherwise improve the video quality. The decoded video blocks in a given frame or picture are then stored in reference picture memory 92, which stores reference pictures used for subsequent motion compensation. Reference picture memory 92 also stores decoded video for later presentation on a display device, such as display device 32 of FIG. 1.

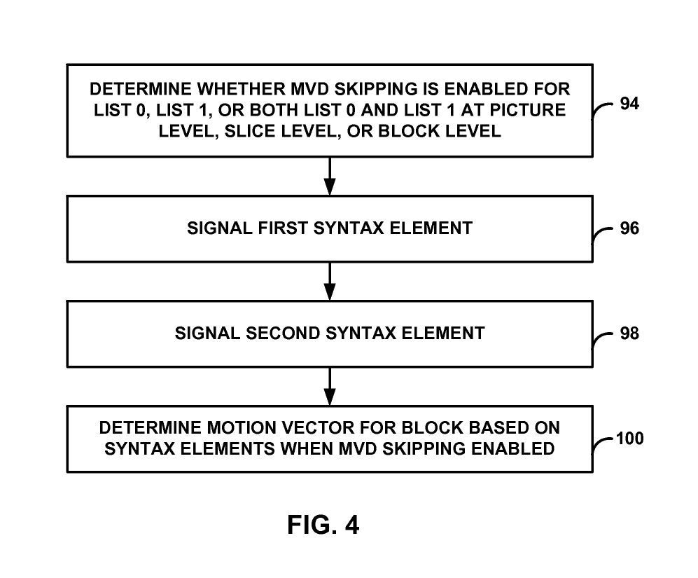

FIG. 4 is a flowchart illustrating an example operation in accordance with one or more example techniques described in this disclosure. A video coder may be configured to implement the example techniques illustrated in FIG. 4. Examples of the video coder include video encoder 20 and video decoder 30.

For example, video encoder 20 may determine whether MVD skipping is enabled for List 0, List 1, or both List 0 and List 1 and whether MVD skipping is enabled at a picture level, slice level, or block level (94). In some examples, video decoder 30 may be configured to infer whether MVD skipping is enabled and for which list or lists, and whether MVD skipping is enabled at the picture level, slice level, or block level without necessarily receiving signaling from the video encoder.

Video encoder 20 may signal a first syntax element (96). As one example, the first syntax element is the MVD_mode flag that indicates whether MVD skipping is enabled. Video encoder 20 may also signal a second syntax element (98). Examples of the second syntax element include the MVD_skipping flag and the MVD_skipping_idc syntax elements. MVD_skipping flag and the MVD_skipping_idc syntax elements may indicate whether MVD skipping is enabled with respect to List 0, List 1, or both List 0 and List 1. Furthermore, video encoder 20 may indicate whether MVD skipping enabled at the picture level, slice level, or block level based on whether video encoder 20 signals at least one of the first syntax element or the second syntax element in the picture header, slice header, in a PU, CU, or LCU, or in the SPS, PPS, or APS. In some examples, video decoder 30 may not need to necessarily receive the first and second syntax elements. In these examples, video decoder 30 may infer the values of the MVD_mode flag and the MVD_skipping flag or MVD_skipping_idc based on the number of neighboring or proximate blocks whose MVD values are approximately equal to zero.

Video decoder 30 may determine the motion vector for a block based on the syntax elements when MVD skipping is enabled (100). For example, when MVD skipping is enabled, video encoder 20 may not signal the MVD, and video decoder 30 may not receive the MVD. In this example, video decoder 30 may determine the motion vector for the block without receiving the MVD. For example, video decoder 30 may set the motion vector of the block equal to the motion vector predictor.

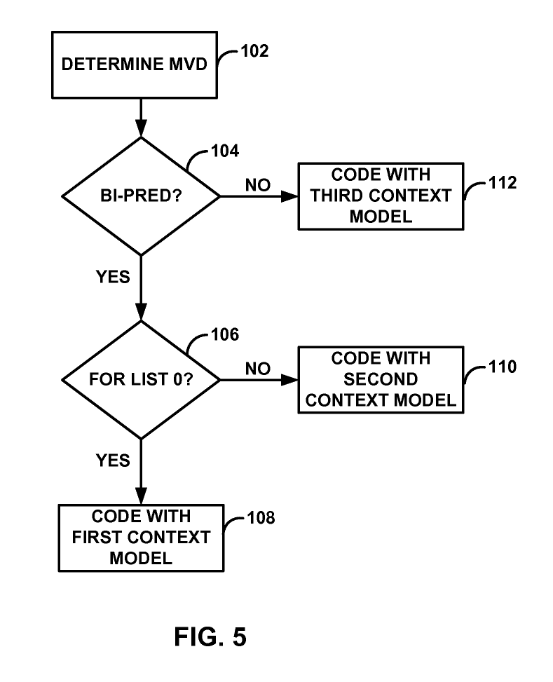

FIG. 5 is a flowchart illustrating another example operation in accordance with one or more example techniques described in this disclosure. Similar to FIG. 4, a video coder may be configured to implement the example techniques illustrated in FIG. 5, and examples of the video coder include video encoder 20 and video decoder 30.

In the example of FIG. 5, a video coder (e.g., video encoder 20 or video decoder 30) may determine the MVD for a block (102). For example, for video encoder 20, the MVD may be the determined MVD between the motion vector and the motion vector predictor. Video encoder 20 may be configured to determine a codeword for the MVD, and encode the codeword in accordance with the example techniques illustrated in FIG. 5. For video decoder 30, the MVD may be the received encoded MVD that is to be decoded. For instance, video decoder 30 may receive the encoded codeword that is to be decoded in accordance with the techniques illustrated in FIG. 5, and video decoder 30 may then determine the MVD value based on the decoded codeword. As described above, the MVD value includes the x-component of the MVD and the y-component of the MVD, and encoding and decoding the MVD value includes encoding and decoding the value of the x-component of the MVD and the value of the y-component of the MVD.

The video coder may determine whether MVD is for a motion vector for a bi-predicted block (104) (e.g., based on the signaling by video encoder 20). If the MVD is for the motion vector for the bi-predicted block (YES of 104), the video coder may determine whether the motion vector refers to a picture in List 0 (106) (e.g., based on the syntax elements signaled by video encoder 20 and received by video decoder 30). If the motion vector refers to a picture in List 0 (YES of 106), the video coder may utilize a first context model to code (e.g., encode or decode) the MVD (108). If the motion vector refers to a picture in List 1 (NO of 106), the video coder may utilize a second, different context model to code the MVD (110).

If the MVD is for the motion vector for a uni-predicted block (NO of 104), the video coder may utilize the third context model to code the MVD (112). In some examples, the third context model may be different than the first and second context models. In some examples, the third context model may be the same as at least one of the first and second context models.

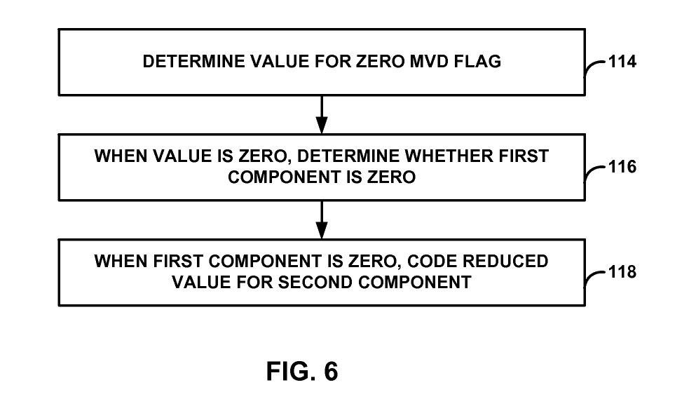

FIG. 6 is a flowchart illustrating another example operation in accordance with one or more example techniques described in this disclosure. Similar to FIGS. 4 and 5, a video coder may be configured to implement the example techniques illustrated in FIG. 6, and examples of the video coder include video encoder 20 and video decoder 30.

The video coder may determine the value of a zero MVD flag (114). For example, video encoder 20 may signal the value of the zero MVD flag to video decoder 30. As another example, video decoder 30 may infer the value of the zero MVD flag without receiving the value from video encoder 20.

When the value of the zero MVD flag is zero, the video coder may determine whether the value of a first component of the MVD is zero (116). For example, in examples where the value of the zero MVD flag is zero, if the value of the MVD is (0, Y), video encoder 20 may signal the value of the x-component first, followed by the value of the y-component. In examples where the value of the zero MVD flag is zero, if the value of the MVD is (X, 0), video encoder 20 may signal the value of the y-component first followed by the value of the x-component.

When the value of the first component is zero, the video coder may code a reduced value for the second component (118). For example, in instances where the MVD value is (0, Y), video encoder 20 may signal the value of (0, Y−1) (i.e., a reduced value for the y-component). In instances where the MVD value is (X, 0), video encoder 20 may signal the value of (X−1, 0) (i.e., a reduced value for the x-component). In these examples, video decoder 30 may decode the reduced value for the second component, and may determine the actual value for the second component based on the reduced value for the second component. For example, video decoder 30 may add one to the value of Y−1 or X−1 to determine the actual value of the y-component or x-component, respectively.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method for coding video data, the method comprising:
coding a first motion vector difference (MVD) value for a first motion vector of a bi-predicted block that refers to a picture in a first reference picture list with a first context model; and
coding a second MVD value for a second motion vector of the bi-predicted block that refers to a picture in a second reference picture list with a second, different context model.

2. The method of claim 1, wherein coding the first MVD value comprises coding at least one of a first bin and a second bin of a plurality of bins of the first MVD value with the first context model, and wherein coding the second MVD value comprises coding at least one of a first bin and a second bin of a plurality of bins of the second MVD value with the second, different context model.

3. The method of claim 2, further comprising:
coding remaining bins of the plurality of bins of the first MVD value in bypass mode; and
coding remaining bins of the plurality of bins of the second MVD value in the bypass mode.

4. The method of claim 2, wherein coding the first MVD value comprises coding the first bin of the plurality of bins of the first MVD value with the first context model, and wherein coding the second MVD value comprises coding the first bin of the plurality of bins of the second MVD value with the second, different context model, the method further comprising:
coding the second bin of the plurality of bins of the first MVD value and the second bin of the plurality of bins of the second MVD value with a shared context.

5. The method of claim 1, wherein coding the first MVD value comprises coding one or more bins of a plurality of bins of the first MVD value with the first context model, and wherein coding the second MVD value comprises coding one or more bins of a plurality of bins of the second MVD value with the second, different context model.

6. The method of claim 5, wherein the one or more bins of the plurality of bins of the first MVD value comprise a first set of bins of the plurality of bins of the first MVD value, and wherein the one or more bins of the plurality of bins of the second MVD value comprise a first set of bins of the plurality of bins of the second MVD value, the method further comprising:
coding a second set of bins of the plurality of bins of the first MVD value and a second set of bins of the plurality of bins of the second MVD value with a shared context.

7. The method of claim 5, wherein the one or more bins of the plurality of bins of the first MVD value comprise a first set of bins of the plurality of bins of the first MVD value, and wherein the one or more bins of the plurality of bins of the second MVD value comprise a first set of bins of the plurality of bins of the second MVD value, the method further comprising:
coding a second set of bins of the plurality of bins of the first MVD value in bypass mode; and
coding a second set of bins of the plurality of bins of the second MVE value in the bypass mode.

8. The method of claim 1, wherein coding the first MVD value comprises coding a first bin of a plurality of bins of the first MVD value with the first context model, and wherein coding the second MVD value comprises coding a first bin of a plurality of bins of the second MVD value with the second, different context model, the method further comprising:
coding a second bin of the plurality of bins of the first MVD value and a second bin of the plurality of bins of the second MVD value with a shared context; and
coding remaining bins of the plurality of bins of the first MVD value and remaining bins of the plurality of bins of the second MVD value in bypass mode.

9. The method of claim 1, further comprising:
coding an MVD value for a motion vector of a uni-predicted block that refers to a picture in one of the first reference picture list and the second reference picture list with a third, different context model.

10. The method of claim 1, further comprising:
coding an MVD value for a motion vector of a uni-predicted block that refers to a picture in one of the first reference picture list and second reference picture list with one of the first context model and the second context model.

11. The method of claim 1, wherein the bi-predicted block comprises a first block, the method further comprising:
determining whether MVD skipping is enabled for the first reference picture list, the second reference picture list, or both the first reference picture list and the second reference picture list; and
determining a motion vector for a second block using a motion vector predictor for the second block and without using an MVD for the motion vector for the second block based on the determination of whether MVD skipping is enabled.

12. The method of claim 11, further comprising:
determining whether MVD skipping is enabled at a picture level, slice level, or block level.

13. The method of claim 1, wherein the bi-predicted block comprises a first block, the method further comprising:
determining whether an MVD value for an MVD of a motion vector for a second block is equal to zero;
when the MVD value for the motion vector for the second block is a non-zero value, determining whether a value for a first component of the MVD is equal to zero; and
when the value for the first component of the MVD is equal to zero, coding a reduced value for a second component of the MVD.

14. The method of claim 13, wherein determining whether the MVD value for the MVD of the motion vector for the second block is equal to zero comprises receiving a zero MVD flag value that indicates whether the MVD value for the motion vector for the second block is equal to zero.

15. The method of claim 13, wherein determining whether the MVD value for the MVD of the motion vector for the second block is equal to zero comprises inferring a zero MVD flag value that indicates whether the MVD value for the motion vector for the second block is equal to zero.

16. The method of claim 1, wherein the first MVD value comprises a difference between a first motion vector predictor and the first motion vector, and the second MVD value comprises a difference between a second motion vector predictor and the second motion vector, the method further comprising:
utilizing the first MVD value and the first motion vector predictor to determine the first motion vector;
utilizing the second MVD value and the second motion vector predictor to determine the second motion vector; and
coding the bi-predicted block based on the first motion vector and the second motion vector.

17. The method of claim 1, wherein coding the first MVD value comprises context adaptive binary arithmetic coding the first MVD value, and wherein coding the second MVD value comprises context adaptive binary arithmetic coding the first MVD value.

18. The method of claim 1,
wherein coding the first MVD value comprises decoding, with a video decoder, the first MVD value for the first motion vector of the bi-predicted block that refers to the picture in the first reference picture list with the first context model, and
wherein coding the second MVD value comprises decoding, with the video decoder, the second MVD value for the second motion vector of the bi-predicted block that refers to the picture in the second reference picture list with the second, different context model.

19. The method of claim 1,
wherein coding the first MVD value comprises encoding, with a video encoder, the first MVD value for the first motion vector of the bi-predicted block that refers to the picture in the first reference picture list with the first context model, and
wherein coding the second MVD value comprises encoding, with the video encoder, the second MVD value for the second motion vector of the bi-predicted block that refers to the picture in the second reference picture list with the second, different context model.

20. A device for coding video data, the device comprising a video coder configured to:
code a first motion vector difference (MVD) value for a first motion vector of a bi-predicted block that refers to a picture in a first reference picture list with a first context model; and
code a second MVD value for a second motion vector of the bi-predicted block that refers to a picture in a second reference picture list with a second, different context model.

21. The device of claim 20, wherein, to code the first MVD value, the video coder is configured to code at least one of a first bin and a second bin of a plurality of bins of the first MVD value with the first context model, and wherein, to code the second MVD value, the video coder is configured to code at least one of a first bin and a second bin of a plurality of bins of the second MVD value with the second, different context model.

22. The device of claim 21, wherein the video coder is configured to:
code remaining bins of the plurality of bins of the first MVD value in bypass mode; and
code remaining bins of the plurality of bins of the second MVD value in the bypass mode.

23. The device of claim 21, wherein, to code the first MVD value, the video coder is configured to code the first bin of the plurality of bins of the first MVD value with the first context model, wherein, to code the second MVD value, the video coder is configured to code the first bin of the plurality of bins of the second MVD value with the second, different context model, and wherein the video coder is configured to:
code the second bin of the plurality of bins of the first MVD value and the second bin of the plurality of bins of the second MVD value with a shared context.

24. The device of claim 20, wherein, to code the first MVD value, the video coder is configured to code one or more bins of a plurality of bins of the first MVD value with the first context model, and wherein, to code the second MVD value, the video coder is configured to code one or more bins of a plurality of bins of the second MVD value with the second, different context model.

25. The device of claim 24, wherein the one or more bins of the plurality of bins of the first MVD value comprise a first set of bins of the plurality of bins of the first MVD value, wherein the one or more bins of the plurality of bins of the second MVD value comprise a first set of bins of the plurality of bins of the second MVD value, and wherein the video coder is configured to:
code a second set of bins of the plurality of bins of the first MVD value and a second set of bins of the plurality of bins of the second MVD value with a shared context.

26. The device of claim 24, wherein the one or more bins of the plurality of bins of the first MVD value comprise a first set of bins of the plurality of bins of the first MVD value, wherein the one or more bins of the plurality of bins of the second MVD value comprise a first set of bins of the plurality of bins of the second MVD value, and wherein the video coder is configured to:
code a second set of bins of the plurality of bins of the first MVD value in bypass mode; and
code a second set of bins of the plurality of bins of the second MVE value in the bypass mode.

27. The device of claim 20, wherein, to code the first MVD value, the video coder is configured to code a first bin of a plurality of bins of the first MVD value with the first context model, wherein, to code the second MVD value, the video coder is configured to code a first bin of a plurality of bins of the second MVD value with the second, different context model, and wherein the video coder is configured to:
code a second bin of the plurality of bins of the first MVD value and a second bin of the plurality of bins of the second MVD value with a shared context; and
code remaining bins of the plurality of bins of the first MVD value and remaining bins of the plurality of bins of the second MVD value in bypass mode

28. The device of claim 20, wherein the video coder is configured to:
code an MVD value for a motion vector of a uni-predicted block that refers to a picture in one of the first reference picture list and the second reference picture list with a third, different context model.

29. The device of claim 20, wherein the video coder is configured to:
code an MVD value for a motion vector of a uni-predicted block that refers to a picture in one of the first reference picture list and second reference picture list with one of the first context model and the second context model.

30. The device of claim 20, wherein the bi-predicted block comprises a first block, and wherein the video coder is configured to:
determine whether MVD skipping is enabled for the first reference picture list, the second reference picture list, or both the first reference picture list and the second reference picture list; and
determine a motion vector for a second block using a motion vector predictor for the second block and without using an MVD for the motion vector for the second block based on the determination of whether MVD skipping is enabled.

31. The device of claim 30, wherein the video coder is configured to:
determine whether MVD skipping is enabled at a picture level, slice level, or block level.

32. The device of claim 20, wherein the bi-predicted block comprises a first block, and wherein the video coder is configured to:
determine whether an MVD value for an MVD of a motion vector for a second block is equal to zero;
when the MVD value for the motion vector for the second block is a non-zero value, determine whether a value for a first component of the MVD is equal to zero; and
when the value for the first component of the MVD is equal to zero, code a reduced value for a second component of the MVD.

33. The device of claim 32, wherein, to determine whether the MVD value for the MVD of the motion vector for the second block is equal to zero, the video coder is configured to receive a zero MVD flag value that indicates whether the MVD value for the motion vector for the second block is equal to zero.

34. The device of claim 32, wherein, to determine whether the MVD value for the MVD of the motion vector for the second block is equal to zero, the video coder is configured to infer a zero MVD flag value that indicates whether the MVD value for the motion vector for the second block is equal to zero.

35. The device of claim 20, wherein the first MVD value comprises a difference between a first motion vector predictor and the first motion vector, and the second MVD value comprises a difference between a second motion vector predictor and the second motion vector, and wherein the video coder is configured to:
utilize the first MVD value and the first motion vector predictor to determine the first motion vector;
utilize the second MVD value and the second motion vector predictor to determine the second motion vector; and
code the bi-predicted block based on the first motion vector and the second motion vector.

36. The device of claim 20, wherein, to code the first MVD value, the video coder is configured to context adaptive binary arithmetic code the first MVD value, and wherein, to code the second MVD value, the video coder is configured to context adaptive binary arithmetic coding the first MVD value.

37. The device of claim 20, wherein the video coder comprises a video decoder, and wherein the video decoder is configured to:
decode the first MVD value for the first motion vector of the bi-predicted block that refers to the picture in the first reference picture list with the first context model; and
decode the second MVD value for the second motion vector of the bi-predicted block that refers to the picture in the second reference picture list with the second, different context model.

38. The device of claim 20, wherein the video coder comprises a video encoder, and wherein the video encoder is configured to:
encode the first MVD value for the first motion vector of the bi-predicted block that refers to the picture in the first reference picture list with the first context model; and
encode the second MVD value for the second motion vector of the bi-predicted block that refers to the picture in the second reference picture list with the second, different context model.

39. The device of claim 20, wherein the device comprises one of:
a wireless communication device;
a microprocessor; and
an integrated circuit.

40. A computer-readable storage medium having instructions stored thereon that when executed cause one or more processors to:
code a first motion vector difference (MVD) value for a first motion vector of a bi-predicted block that refers to a picture in a first reference picture list with a first context model; and
code a second MVD value for a second motion vector of the bi-predicted block that refers to a picture in a second reference picture list with a second, different context model.

41. A device comprising:
means for coding a first motion vector difference (MVD) value for a first motion vector of a bi-predicted block that refers to a picture in a first reference picture list with a first context model; and
means for coding a second MVD value for a second motion vector of the bi-predicted block that refers to a picture in a second reference picture list with a second, different context model.
